(19) United States
(12) Patent Application Publication
(10) Pub. No.: US 2026/0247058 A1
(43) Pub. Date: Aug. 20, 2026

(54) ACOUSTIC SYSTEM, SIGNAL GENERATION DEVICE AND METHODS FOR ENHANCING PRIVACY IN THE CONTEXT OF BONE CONDUCTED SOUND

(71) Applicant: Sound Solutions International (Zhenjiang) Co. Ltd., Zhenjiang City (CN)

(72) Inventors: Friedrich Reining, Vienna (AT); Manfred Heitzinger, Ebreichsdorf (AT); Matthias Possl, Vienna (AT); Gergo Laszlo Gottlieb, Vienna (AT); Stefan Gebhardt, Vienna (AT); Mario Schwarz, Vienna (AT)

(21) Appl. No.: 19/537,875

(22) Filed: Feb. 12, 2026

(30) Foreign Application Priority Data
Feb. 18, 2025 (AT) A50108/2025

(51) Int. Cl. H04R 1/10; H04R 3/04; H04R 9/06; H04R 29/00

(52) U.S. Cl. CPC H04R 1/1041; H04R 1/1075; H04R 3/04; H04R 9/06; H04R 29/002; H04R 2460/13

(57) ABSTRACT

The invention relates to an acoustic system, which comprises a housing, which is intended to be pressed against a head of a user for acoustic bone conduction, an electrodynamic actuator, which is acoustically coupled to the housing and emits sound primarily by bone conduction, and a speaker, which emits sound primarily by air conduction. The acoustic system additionally comprises an electronic sound signal circuit, which generates an actuator signal for the electrodynamic actuator and a speaker signal for the speaker based on an audio input signal so that in an offside location offside of the user sound pressure level of sound originating from the acoustic system is reduced. In addition, the invention relates to a signal generation device for generating an actuator signal and a speaker signal and for transmitting the same to a sound emitting device. Finally, the invention relates to methods of operating and tuning an acoustic system.

### PRIORITY

This application claims priority to Austrian Patent Application No. A50108/2025, entitled “Acoustic System, Signal Generation Device and Methods for Enhancing Privacy in the Context of Bone Conducted Sound,” and filed on Feb. 18, 2025, which is hereby incorporated by reference in its entirety.

### BACKGROUND

### a. Technical Field

The present invention relates to an acoustic field, and particularly to an acoustic system, signal generation device and methods for enhancing privacy in the context of bone conducted sound.

### b. Background of the Invention

The invention relates to an acoustic system, which comprises a housing, of which at least a part is intended to be pressed against the head of a user (who uses the acoustic system) for acoustic bone conduction, an electrodynamic actuator, a speaker and an electronic sound signal circuit. The electrodynamic actuator comprises an actuator motor and a moving mass driven by the actuator motor or formed by a part of the actuator motor, wherein the electrodynamic actuator is acoustically coupled to the housing and designed to emit sound to be transmitted primarily by bone conduction. The speaker comprises a speaker motor and a membrane driven by the speaker motor, wherein the speaker is designed to emit sound to be transmitted primarily by air conduction. Finally, the electronic sound signal circuit is designed to generate an actuator signal for driving the actuator motor and a speaker signal for driving the speaker motor. In addition, the invention relates to a signal generation device for generating an actuator signal and a speaker signal and for transmitting the actuator signal and the speaker signal to a sound emitting device. Finally, the invention relates to methods of operating an acoustic system and of tuning an acoustic system.

An acoustic system, a signal generation device and methods of the above kinds are each generally known. By use of these kinds of acoustic systems, sound is transmitted both via bone conduction and air conduction to a user's middle ear and inner ear. In such a way, the sound impression for the user can be improved over simple bone conduction based devices, which may have unimpressive sound at certain frequency ranges. While generally conduction based devices are used to avoid disturbance to people in the vicinity of the user and to ensure privacy for the user, in reality, sound originating from the electromagnetic transducer, by excitation of the housing offside of the user's ear unintendedly also causes a sound emission into the vicinity of the user. On the one hand, people in the vicinity of the user could be disturbed by that sound, and on the other hand, this sound emission causes privacy issues because that people could hear private or even confidential information, which intendedly is only directed to the user of the acoustic system.

### SUMMARY OF THE INVENTION

Thus, it is an object of the invention to overcome the above drawbacks and to provide a better acoustic system, a better signal generation device and better methods for operating an acoustic system and for tuning an acoustic system. In particular, a solution shall be provided, which enhances privacy for users of the acoustic system.

The inventive problem is solved by an acoustic system as defined in the opening paragraph, wherein the electronic sound signal circuit is designed to generate an actuator signal for driving the actuator motor and a speaker signal for driving the speaker motor based on an audio input signal in a way that in an offside location offside of the user, offside sound transmitted over air including sound transmitted over air originating from the electrodynamic actuator (which excites the housing) is less loud than in a state, in which the speaker is turned off. In other words, in the offside location, sound transmitted over air originating from the electrodynamic actuator is cancelled or at least reduced or suppressed by the sound transmitted over air originating from the speaker.

Furthermore, the inventive problem is solved by a signal generation device for generating an actuator signal and a speaker signal and for transmitting the actuator signal and the speaker signal to a sound emitting device, wherein the sound emitting device comprises
a housing, of which at least a part is intended to be pressed against a head of a user (who uses the acoustic system) for acoustic bone conduction,
an electrodynamic actuator with an actuator motor and a moving mass driven by the actuator motor or formed by a part of the actuator motor, wherein the electrodynamic actuator is acoustically coupled to the housing and designed to emit sound to be transmitted primarily by bone conduction, and
a speaker with a speaker motor and a membrane driven by the speaker motor, wherein the speaker is designed to emit sound to be transmitted primarily by air conduction, and
wherein the signal generation device comprises an electronic sound signal circuit, which is designed to generate an actuator signal for the actuator motor and a speaker signal for driving the speaker motor based on an audio input signal in a way that in an offside location offside of the user, offside sound transmitted over air including sound transmitted over air originating from the electrodynamic actuator (which excites the housing) is less loud than in a state, in which the speaker is turned off.

In addition, the inventive problem is solved by a method of operating an acoustic system of the above kind, wherein the electronic sound signal circuit generates an actuator signal for driving the actuator motor and a speaker signal for driving the speaker motor based on an audio input signal in a way that in an offside location offside of the user, offside sound transmitted over air including sound transmitted over air originating from the electrodynamic actuator (which excites the housing) is less loud than in a state, in which the speaker is turned off.

Finally, the inventive problem is solved by a method of tuning an acoustic system of the above kind, which comprises the steps of
applying an audio input signal to the acoustic system,
measuring offside sound generated by the acoustic system in an offside location offside of the user (who uses the acoustic system) or offside an equivalent arrangement of the acoustic system on a user model,
setting a ratio between the actuator signal and the speaker signal (concretely the ratio between the signal levels) and a phase shift between the actuator signal and the speaker signal in a way that offside sound transmitted over air in said offside location is less loud than in a state, in which the speaker is turned off (and even reaches a minimum), and
setting the chosen ratio and the chosen phase shift in the electronic sound signal circuit.

By the proposed measures, disturbance to people in the vicinity of the user is avoided and privacy for the user is ensured or at least improved. Usually, one would think that it gets louder in the offside location when the speaker is turned on, but the opposite is true here. Unintended excitation of the housing offside of the user's ear does not disappear, however, by using proper values for the signal levels of the actuator signal and the speaker signal and proper values for the phase shift between the actuator signal and the speaker signal in the electronic sound signal circuit, both sound suppression and signal to noise ratio can be influenced.

The above is at least true in a part of the audible frequency range. It should also be noted that there could be locations offside of the user, where the above definition is not true. It should also be noted that the above definition is meant under the condition that the power of the actuator signal remains unchanged when the speaker is turned on and off.

For example, a distance between the offside location and a user's ear, at which the housing contacts the user for bone conduction, is in a range between 20 cm and 100 cm (in particular in a range between 40 cm and 80 cm). Hence, the sound suppression is limited to a distance range, in which violation of privacy is considered to be principally possible. It is unlikely that people can get closer than 20 cm (or 40 cm) without causing the user's attention, and it is unlikely that the offside sound is loud enough in a distance range over 100 cm (or 80 cm) to be clearly audible by people other than the user. In particular, the offside sound transmitted over air including the sound transmitted over air originating from the electrodynamic actuator can be less loud in all offside locations or in at least 80% of all offside locations in the given distance range. In an alternative embodiment, the above definition can refer to an average tuning parameter (e.g. sound suppression, improvement of signal to noise ratio and so on) in all offside locations or in at least 80% of all offside locations in the given distance range.

In another embodiment, the offside location is arranged on an off-ear axis, which is a horizontal axis perpendicular to a viewing direction of the user starting at an ear canal of the user. In particular, the offside sound transmitted over air including the sound transmitted over air originating from the electrodynamic actuator can be less loud in all offside locations or in at least 80% of all offside locations on the off-ear axis. In an alternative embodiment, the above definition can refer to an average tuning parameter (e.g. sound suppression, improvement of signal to noise ratio and so on) in all locations or in at least 80% of all offside locations on the off-ear axis.

It is also possible that the offside location is arranged in a cone volume of a (virtual) cone, which opens from a user's ear, at which the housing contacts the user for bone conduction, wherein the cone opens at an angle of 120° with respect to an off-ear axis, which is a horizontal axis perpendicular to a viewing direction of the user starting at an ear canal of the user. In particular, the offside sound transmitted over air including the sound transmitted over air originating from the electrodynamic actuator can be less loud in all offside locations or in at least 80% of all offside locations within the cone volume. In an alternative embodiment, the above definition can refer to an average tuning parameter (e.g. sound suppression, improvement of signal to noise ratio and so on) in all offside locations or in at least 80% of all offside locations within the cone volume. More particularly, a distance between the offside location offside and a user's ear, at which the housing contacts the user for bone conduction, can be in a range between 20 cm and 100 cm (in particular in a range between 40 cm and 80 cm). In other words, the offside locations are arranged in a frustum of a (virtual) cone then.

It should be noted that the aforementioned limitations of the range or space, in which the offside location(s) is/are arranged does not mean that sound suppression cannot also occur in locations out of the limitations of the range or space. This rather should mean that within the given distance range, on the off-ear axis or in the cone volume sound suppression can be considered and termed as “nominal sound suppression,” whereas sound suppression out of the given distance range can be considered and termed as “incidental sound suppression.” Nominal sound suppression is guaranteed, whereas incidental sound suppression can occur or not.

“Primarily transmitted by bone conduction” in the given context particularly means that the transmission of sound originating from the electrodynamic actuator by bone conduction is louder than by air conduction. More particularly this can mean that transmission of sound originating from the electrodynamic actuator by bone conduction is louder than by air conduction by at least 10 dB (equivalent) sound pressure level.

Similarly, “primarily transmitted by air conduction” in the given context particularly means that the transmission of sound originating from the electrodynamic speaker by air conduction is louder than by bone conduction. More particularly this can mean that transmission of sound originating from the speaker by air conduction is louder than by bone conduction by at least 10 dB (equivalent) sound pressure level.

However, that does not mean that the electrodynamic actuator is louder than the speaker or vice versa.

The above definitions particularly can relate to a subjective hearing perception of a user, wherein sound transmitted by bone conduction, which by the user (subjectively) is perceived as loud as the same sound transmitted by air conduction, is considered to have the same (equivalent) sound pressure level. Accordingly, structural borne sound transmitted by bone conduction with a dedicated (equivalent) “sound pressure” level and sound transmitted by air conduction with the same (real) sound pressure level are perceived as being equally loud or are perceived as having the same loudness or sound pressure level. “Loudness” in the given context can also be defined and termed as “sound pressure level defined by equal balanced measurement” or “equal balance sound pressure level.” Generally, the (perceived) loudness can be taken out of an equal-loudness contour or curve, which is the measurement of the sound pressure level over the frequency spectrum, for which a listener perceives a constant loudness when pure steady (sine) tones are presented to him. The unit of the loudness is the “phon.” As the (perceived) loudness may substantially vary from person to person, a (nominal) loudness, for example, can be defined for a person of a certain age (e.g. an age of 30), for a group of persons of a certain age (e.g. an age of 30) or for a group of persons in a certain age range (e.g. in an age range of 20 to 70).

“Sound suppression” in the context of this disclosure particularly means a reduction of the sound pressure level of offside sound transmitted over air including sound transmitted over air originating from the electrodynamic actuator in an offside location offside of the user in the on-state of the speaker in relation to the speaker being turned off. It can be measured by means of a microphone placed in the offside location, wherein the speaker is activated and deactivated to determine the ratio between suppressed sound pressure level and non-suppressed sound pressure level. The audio input signal can be a sine tone with a certain frequency. The determination of the sound suppression can be done for a number of different frequencies, so that the sound suppression can be determined over a particular frequency range.

The “signal to noise ratio (SNR)” in the context of this disclosure particularly means the ratio between a loudness of the sound perceived by the user or a user model (which is considered as “signal”) and a sound pressure level of the offside sound in said offside location offside of the user (which is considered as “noise”). The signal to noise ratio can be measured by use of an external speaker and an external microphone as follows: In a first step, the “signal” level is measured. For this reason, the acoustic system is set to an output level where the user perceives the sound generated by the external sound source and the sound produced by the acoustic system as equally loud. For a proper measurement, sound output may be toggled between the external sound source and the acoustic system. The external microphone is placed close to the user's ear or even in the ear canal for this measurement and measures the sound pressure level (which is the equivalent sound pressure level perceived by the user) of the “signal.” In a second step, the external sound source is switched off, and offside sound caused by the acoustic system is measured now by the external microphone. For this reason, the external microphone is placed in the offside location and measures the sound pressure level of the “noise.” By dividing the results of both measurements, the signal to noise ratio can be calculated. It should be noted that the audio signal shall be the same for the external sound source and the acoustic system in both measuring steps and can be a sine tone with a certain frequency. The determination of the signal to noise ratio can be done for a number of different frequencies, so that the signal to noise ratio can be determined over a particular frequency range.

The “improvement of the signal to noise ratio (ASNR)” is the change of the signal to noise ratio in the on-state of the speaker compared to its off-state. According to the proposed measures, the signal to noise ratio gets better (higher) when the speaker is turned on. It should be noted that the term “signal to noise ratio” is not mandatory for the ratio in question. Instead, it can also be termed as “user to listener ratio” for example.

By setting proper values for the signal levels of the actuator signal and the speaker signal and for the phase shift between the actuator signal and the speaker signal in the electronic sound signal circuit, both the sound suppression and the signal to noise ratio can be influenced. By tuning the electronic sound signal circuit properly, both a satisfying sound suppression and a satisfying signal to noise ratio can be achieved or provided.

The sound suppression and the signal to noise ratio are substantially influenced by the ratio and the phase shift between the actuator signal and the speaker signal. However, it should be noted that not only the sound suppression and the signal to noise ratio respectively vary over the ratio and the phase shift between the actuator signal and the speaker signal, but also the total power and the efficiency of the electrodynamic actuator and the speaker varies.

In particular, tuning of the acoustic system can be done at a (nominal) loudness of 75 dB (i.e. for an equivalent sound pressure level of 75 dB perceived by the user). This also means that the conditions and measures proposed for the acoustic system in particular can be meant at a (nominal) loudness of 75 dB. In particular, the electronic sound signal circuit can be designed to cause a sound suppression in the offside location in the on-state of the speaker in relation to the off-state of the speaker at a loudness of 75 dB perceived by the user and/or for a sinusoidal audio input signal at a frequency of 3 kHz.

The sound pressure level is the logarithmic ratio between the squared effective value of an (actual) sound pressure and a nominal sound pressure. Accordingly, the values presented herein in decibel are particularly meant as such squared effective values.

As said, the electronic sound signal circuit causes a sound suppression caused by the speaker in the offside location in relation to the speaker being turned off. However, that does not mean that the electronic sound signal circuit must perform the necessary operations on an audio input signal “on the fly.” In contrast, an audio input signal may be processed by the electronic sound signal circuit and stored for later use. In such a case, a stored and already processed audio file can be “streamed” to the electrodynamic actuator and to the speaker without being processed in the given way once more. However, that does not exclude further processing of the audio file in another way. For example, the audio stream may pass an equalizer, by which the user can adjust the audio output to his personal demands, before it is output via the electrodynamic actuator and the speaker.

The actuator motor is designed to move the moving mass along an actuator axis and can comprise an actuator coil arrangement with at least one actuator coil, which has an electrical conductor in the shape of loops running around the actuator axis in a loop section. In addition, the actuator motor can comprise an actuator magnet system, which is designed to generate a magnetic field transverse to the conductor in the loop section.

Similarly, the speaker motor is designed to move the membrane along a speaker axis and can comprise a speaker coil arrangement with at least one speaker coil, which has an electrical conductor in the shape of loops running around the speaker axis in a loop section. In addition, the speaker motor can comprise a speaker magnet system, which is designed to generate a magnetic field transverse to the conductor in the loop section, wherein the speaker coil arrangement is mounted to the membrane.

The electrodynamic actuator and the speaker can be embodied as a combined actuator speaker device and can share a common magnet system. In particular, the actuator axis and the speaker axis can coincide in such an embodiment.

Finally, it is noted that deviations from given numbers defined in the patent claims, which are unavoidable in reality due to technical tolerances, generally shall be covered by those patent claims anyway. In particular, this means that numbers defined in the patent claims are considered to include a range of +/−10% in view of the base value.

Further advantageous embodiments are disclosed in the claims and in the description as well as in the figures.

In an advantageous embodiment, the sound suppression in the offside location offside of the user caused in the on-state of the speaker in relation to a state, in which the speaker is turned off
is at least 6 dB (which equals a factor 2) and/or
can reach (at least a local or even a global) maximum in view of a change of a ratio between the actuator signal and the speaker signal (concretely the ratio between the signal levels) or in view of a change of a phase shift between the actuator signal and the speaker signal.

In this way, the proposed measures (in particular tuning the acoustic system and setting proper values for the signal levels and the phase shift of the actuator signal and the speaker signal) focus on a value for the sound suppression. In the first variant, a sound suppression of at least 6 dB shall be achieved, in the second variant a maximum of the sound suppression shall be reached. The latter means, that a change of the ratio (or the signal levels) or the phase shift between the actuator signal and the speaker signal leads to a reduction of the sound suppression and accordingly to a worse sound suppression. It should be noted that the aforementioned conditions can be used in combination what means that a maximum sound suppression of at least 6 dB shall be achieved.

In an alternative embodiment, the sound suppression can be related to the power consumption of the electrodynamic actuator and the speaker, or in other words, the ratio between the sound suppression and said power consumption can be taken as a measure. Accordingly, in such a case, at a loudness of 75 dB perceived by the user, in the offside location offside of the user, preferably

$${K}_{1} = \frac{S S U P}{{P}_{ACS} + {P}_{S P S}} > 10 {W}^{- 1}$$

and/or
the parameter K₁ reaches (at least a local or even a global) maximum in view of a change of a ratio between the actuator signal and the speaker signal (concretely the ratio between the signal levels) or in view of a change of a phase shift between the actuator signal and the speaker signal,
wherein P_{ACS} is an electric power of the actuator signal, P_{SPS} is an electric power of the speaker signal and SSUP is a sound suppression caused by the speaker in the offside location in relation to the speaker being turned off.

By taking the power consumption of the electrodynamic actuator and the speaker as a measure, settings, where a high sound suppression is obtained at the cost of an (unfavorable) high power consumption, are avoided. It should be noted that in the above equation, PACS and PSPS are meant in the on-state of both the electrodynamic actuator and the speaker (and not with the speaker turned off).

In another embodiment, the sound suppression can be multiplied with the ratio between the actuator power and the total power consumption of the electrodynamic actuator and the speaker. Accordingly, in such a case, in the offside location offside of the user, preferably

$${K}_{2} = \frac{{P}_{A C S}}{{P}_{A C S} + {P}_{S P S}} \cdot SSUP > 1.3$$

and/or
the parameter K₂ reaches a maximum in view of a change of a ratio between the actuator signal and the speaker signal or in view of a change of a phase shift between the actuator signal and the speaker signal,
wherein P_{ACS} is an electric power of the actuator signal, P_{SPS} is an electric power of the speaker signal and SSUP is a sound suppression caused by the speaker in the offside location in relation to the speaker being turned off.

By taking the relative power consumption of the electrodynamic actuator as a measure, settings, where a high sound suppression is obtained at the cost of an (unfavorable) high power consumption of the electrodynamic actuator, are avoided. It should be noted that in the above equation, P_{ACS} and P_{SPS} are meant in the on-state of both the electrodynamic actuator and the speaker (and not with the speaker turned off).

In another advantageous embodiment, an improvement of a signal to noise ratio between a loudness of the sound perceived by the user or a user model and a sound pressure level of the offside sound in said offside location offside of the user caused in the on-state of the speaker in relation to a state, in which the speaker is turned off
can be at least 6 dB (which equals a factor 2) and/or
can reach (at least a local or even a global) maximum in view of a change of a ratio between the actuator signal and the speaker signal (concretely the ratio between the signal levels) or in view of a change of a phase shift between the actuator signal and the speaker signal.

In this way, the proposed measures (in particular tuning the acoustic system and setting proper values for the signal levels and the phase shift of the actuator signal and the speaker signal) focus on the improvement of the signal to noise ratio. In the first variant, an improvement of at least 6 dB shall be achieved, in the second variant a maximum of the improvement shall be reached. The latter means that a change of the ratio (or the signal levels) or the phase shift between the actuator signal and the speaker signal leads to a reduction of the improvement of the signal to noise ratio and accordingly to a worsening. It should also be noted that the aforementioned conditions can be used in combination what means that a maximum of the improvement of the signal to noise ratio of at least 6 dB shall be achieved.

In an alternative embodiment, the improvement of the signal to noise ratio can be related to the power consumption of the electrodynamic actuator and the speaker, or in other words, the ratio between said improvement and said power consumption can be taken as a measure. Accordingly, in such a case, at a loudness of 75 dB perceived by the user, in the offside location offside of the user, preferably

$${K}_{3} = \frac{Δ SNR}{{P}_{ACS} + {P}_{S P S}} > 10 {W}^{- 1}$$

and/or
the parameter K₃ reaches (at least a local or even a global) maximum in view of a change of a ratio between the actuator signal and the speaker signal or in view of a change of a phase shift between the actuator signal and the speaker signal,
wherein P_{ACS} is an electric power of the actuator signal, P_{SPS} is an electric power of the speaker signal and ΔSNR is the improvement of the signal to noise ratio between a loudness of the sound perceived by the user or a user model and a sound pressure level of the offside sound in said offside location.

By taking the power consumption of the electrodynamic actuator and the speaker as a measure, settings, where a high improvement of the signal to noise ratio is obtained at the cost of an (unfavorable) high power consumption, are avoided.

In another embodiment, the improvement of the signal to noise ratio can be multiplied with the ratio between the actuator power and the total power consumption of the electrodynamic actuator and the speaker. Accordingly, in such a case, in the offside location offside of the user, preferably

$${K}_{4} = \frac{{P}_{A C S}}{{P}_{A C S} + {P}_{S P S}} \cdot Δ SNR > 1.3$$

and/or
the parameter K₄ reaches a maximum in view of a change of a ratio between the actuator signal and the speaker signal or in view of a change of a phase shift between the actuator signal and the speaker signal,
wherein P_{ACS} is an electric power of the actuator signal, P_{SPS} is an electric power of the speaker signal and ΔSNR is an improvement of a signal to noise ratio between a loudness of the sound perceived by the user or a user model and a sound pressure level of the offside sound in said offside location caused in the on-state of the speaker in relation to a state, in which the speaker is turned off.

By taking the relative power consumption of the electrodynamic actuator as a measure, settings, where a high improvement of the signal to noise ratio is obtained at the cost of an (unfavorable) high power consumption of the electrodynamic actuator, are avoided. It should be noted that in the above equation, PACS and PSPS are meant in the on-state of both the electrodynamic actuator and the speaker (and not with the speaker turned off).

In yet another alternative embodiment, the aforementioned measures can be combined. Accordingly, in such a case, at a loudness of 75 dB perceived by the user, in the offside location offside of the user, preferably

$${K}_{5} = \frac{S SUP \cdot Δ SNR}{{P}_{ACS} + {P}_{S P S}} > 20 {W}^{- 1}$$

and/or
the parameter K₅ reaches (at least a local or even a global) maximum in view of a change of a ratio between the actuator signal (concretely the ratio between the signal levels) and the speaker signal or in view of a change of a phase shift between the actuator signal and the speaker signal,
wherein P_{ACS} is an electric power of the actuator signal, P_{SPS} is an electric power of the speaker signal, SSUP is a sound suppression caused by the speaker in the offside location in relation to the speaker being turned off and ΔSNR is the improvement of the signal to noise ratio between a loudness of the sound perceived by the user or a user model and a sound pressure level of the offside sound in said offside location. Again settings, where sound suppression is done at the cost of an (unfavorable) high power consumption, are avoided.

Generally, the aforementioned conditions and equations can also be related to the (absolute) signal to noise ratio instead of the improvement of the same. In other words, the (absolute) signal to noise ratio can be used in the aforementioned conditions and equations instead of the improvement of the signal to noise ratio.

Accordingly, a signal to noise ratio between a loudness of the sound perceived by the user or a user model and a sound pressure level of the offside sound in said offside location
can be at least 20 dB (which equals a factor 10) and/or
can reach (at least a local or even a global) maximum in view of a change of a ratio between the actuator signal and the speaker signal (concretely the ratio between the signal levels) or in view of a change of a phase shift between the actuator signal and the speaker signal.

Further on, it is also beneficial
if at a loudness of 75 dB perceived by the user, in the offside location offside of the user,

$${K}_{6} = \frac{S N R}{{P}_{A C S} + {P}_{S P S}} > 50 {W}^{- 1}$$

and/or
if in the offside location offside of the user,

$${K}_{7} = \frac{{P}_{A C S}}{{P}_{A C S} + {P}_{S P S}} \cdot SNR > 6.5$$

and/or
if at a loudness of 75 dB perceived by the user, in the offside location offside of the user,

$${K}_{8} = \frac{S SUP \cdot SNR}{{P}_{A C S} + {P}_{SPS}} > 100 {W}^{- 1}$$

and/or
if the given one of the parameters K₆ . . . K₈ reaches (at least a local or even a global) maximum in view of a change of a ratio between the actuator signal and the speaker signal or in view of a change of a phase shift between the actuator signal and the speaker signal,
wherein in all cases, P_{ACS} is an electric power of the actuator signal, P_{SPS} is an electric power of the speaker signal, SSUP is a sound suppression caused by the speaker in the offside location in relation to the speaker being turned off and SNR is a signal to noise ratio between a loudness of the sound perceived by the user or a user model and a sound pressure level of the offside sound in said offside location.

Beneficially, the sound transmitted over air including the sound transmitted over air originating from the electrodynamic actuator can be less loud in a frequence range of 20 Hz to 20 kHz. In this way, the proposed measures for the sound suppression are limited to an audible frequency range so that the tuning of the acoustic system may get easier. In particular, the frequency range can be limited to a range of 1 kHz to 10 kHz and hence to a frequency range, in which the electrodynamic actuator is considered to operate efficiently and in which a substantial sound suppression can be achieved.

Generally, one should note that the ratio between the speaker and the actuator signal may also include the values 0 and ∞. In other words, it can be that only the electrodynamic actuator is activated (ratio=0) or only the speaker is activated (ratio=∞). Reasons for that can be the efficiency of the electrodynamic actuator or the speaker respectively. If the electrodynamic actuator is very inefficient in a particular frequency range, it could be advantageous if only the speaker is activated and vice versa to keep the total power consumption of the acoustic system low.

Beneficially, a ratio and a phase shift between the actuator signal and the speaker signal at a given frequency can vary over a total output power of the electrodynamic actuator and the speaker. In this way, non-linearities of the electrodynamic actuator and the speaker leading to varying efficiency over frequency can be taken into account.

Beneficially, a force, with which the housing is intended to be pressed against the head of a user, can be in a range between 0.05 N and 5 N. In this way, a satisfying coupling can be ensured between the housing of the acoustic system and the head of the user without disturbing wearing comfort. In particular, the equivalent sound pressure level of bone conducted sound is related to or is measured in this force range.

Beneficially, the electronic sound signal circuit for a hearing perception of the user can be designed to mix both sound originating from the electrodynamic actuator, which primarily is transmitted by bone conduction, and sound originating from the speaker, which primarily is transmitted by air conduction, wherein a share of the hearing perception of the user formed by sound originating from the electrodynamic actuator and a remaining share of the hearing perception of the user formed by sound originating from the speaker vary over the frequency of the sound. In this way, the sound impression for the user may be improved because the electrodynamic actuator can have comparably poor performance in some frequency ranges. In such frequency ranges, speaker sound is increased to achieve a satisfying sound impression over the whole desired frequency range. It should be noted that mixing the sound is not limited to varying signal levels but does also include variation of the phase shift. In other words, the actuator signal and the speaker signal may be phase shifted to each other over frequency. By variation of the signal levels and/or the phase shift, a hearing perception of the user can be optimized. In particular, this means that perceived loudness can be maximized by the tuning signal levels and/or the phase shift.

In particular, in the aforementioned embodiment, the share formed by the sound originating from the electrodynamic actuator may be higher than the remaining share formed by the sound originating from the speaker
above a cutoff frequency or
above a first frequency and below a higher second frequency.

Beneficially, the electronic sound signal circuit can be designed to generate a filtered actuator signal as part of the speaker signal. In particular, the filtered actuator signal can be generated by a privacy enhancement filter. In fact, the function of the sound suppression (mainly) is integrated in the privacy enhancement filter here, whereas providing a satisfying sound impression for the user (mainly) is integrated in the actuator filter and the speaker filter. However, these features may particularly be seen as a functional representation of a special embodiment, which is not necessarily reflected in the physical acoustic system one by one. In other words, this means that the crosslinking of an actuator signal path and a speaker signal path, which is provided by the privacy enhancement filter is not mandatory. Instead, in the acoustic system, this crosslinking may be represented only functionally without a real physical cross connection.

In another beneficial embodiment, the electronic sound signal circuit can be designed to provide a delay time or phase shift between sound transmitted over air, which originates from the electrodynamic actuator, and sound transmitted over air originating from the speaker. The delay time or phase shift particularly can be used to compensate a group delay time of the privacy enhancement filter. Accordingly, the actuator signal can be delayed so that it is output in time with the speaker signal despite a delay caused by the privacy enhancement filter. The group delay time of a filter is not constant so that a phase shift may be used. In one embodiment, an all-pass filter with a constant (magnitude) transfer function=1 and a desired phase response can be used. However, one should note that the delay time or phase shift is not limited to the aforementioned functions but can also involve a delay time or phase shift needed for sound suppression or a satisfying signal to noise ratio. Generally, such a delay time or phase shift mainly depends on the different characteristics of the different transmission paths, i.e. on the different characteristics of bone conduction vs. air conduction. It should be noted that depending on the position of the speaker and wiring of the speaker, a delay time or phase shift may be dispensable.

In yet another beneficial embodiment, the electronic sound signal circuit can comprise
an audio input being designed to receive the audio input signal,
an actuator sound output, which is connected to the actuator motor,
a speaker sound output, which is connected to the speaker motor,
an actuator signal path between the audio input and the actuator sound output and a speaker signal path between the audio input and the speaker sound output,
an actuator signal processing unit, which is arranged in the actuator signal path and which is designed to generate the actuator signal based on the audio input signal and to feed the actuator signal to the actuator sound output, and
a speaker signal processing unit, which is arranged in the speaker signal path and which is designed to generate the speaker signal based on the audio input signal and to feed the speaker signal to speaker sound output.

It has turned out that this structure is advantageous for the proposed measures.

For example,
the actuator signal processing unit can comprise an actuator filter and/or
the speaker signal processing unit can comprise a speaker filter.

In particular, the actuator filter and/or the speaker filter can be designed to filter the audio input signal.

Accordingly, the level and phase shift of the actuator signal and level and phase shift of the speaker signal and hence ratio and phase shift between the actuator signal and the speaker signal can be influenced by the actuator filter and/or the speaker filter.

In the above context, particularly
the actuator filter can have a high-pass characteristics or band-pass characteristics and/or
the speaker filter can have a low-pass characteristics or band-stop characteristics.

In turn, a share formed by the sound originating from the electrodynamic actuator may be higher than the remaining share formed by the sound originating from the speaker above a cutoff frequency or above a first frequency and below a higher second frequency.

In a very advantageous embodiment, the actuator filter and the speaker filter provide both
mixing sound originating from the electrodynamic actuator and sound originating from the speaker as mentioned before and
generating a filtered actuator signal as part of the speaker signal as mentioned before.

So, the actuator filter and the speaker filter, on the one hand, provide a ratio and a phase shift between the actuator signal and the speaker signal, and on the other hand, a (functional but no physical) crosslinking of the actuator signal path and the speaker signal path. Concretely, the filtered actuator signal (which is generated by the privacy enhancement filter in the aforementioned embodiment) is generated by the speaker filter here, or in other words the privacy enhancement filter is an integral part of the speaker filter in this embodiment. In this way, a very compact design of the electronic sound signal circuit is obtained.

Beneficially, the electronic sound signal circuit can comprise a delaying or phase shifting unit, which is designed to provide the delay time or phase shift and which is arranged in the actuator signal path or the speaker signal path. Accordingly, a delay time or phase shift between sound transmitted over air, which originates from the electrodynamic actuator, and sound transmitted over air originating from the speaker can be provided.

In yet another beneficial embodiment,
the actuator signal processing unit can comprise an actuator amplification stage, which is designed to amplify an input signal with an actuator gain and/or
the speaker signal processing unit can comprise a speaker amplification stage, which is designed to amplify an input signal with a speaker gain.
   In this way, proper signal levels can be achieved for the electrodynamic actuator and the speaker.

In particular, the actuator amplification stage can be designed to amplify an output signal of the actuator filter and/or the speaker amplification stage can be designed to amplify an output signal of the speaker filter. In other words, the filters are arranged ahead of the amplification stages in this embodiment so that low power filters can be used.

Advantageously, the generation of the actuator signal and the speaker signal can be done without the use of a microphone and/or an acceleration sensor of the acoustic system. That means that no sensor measurement is required for the proposed sound suppression, but sound suppression is done only based on the audio input signal.

Generally, an actuator axis, along which the actuator motor moves, and a speaker axis, along which the speaker motor moves,
can be parallel to each other,
can be turned against each other by 90° or
can coincide.

In the first case, the moving mass of the speaker directly may influence the vibration caused by the electrodynamic actuator. In the second case, the moving masses of the electrodynamic actuator and the speaker are more or less decoupled what may ease tuning of the acoustic system. The last case particularly is related to embodiments, where the electrodynamic actuator and the speaker are embodied as a combined (and very compact) actuator speaker device. One should note that although the aforementioned orientation of the axes is beneficial, other angles between the actuator axis and the speaker axis are possible as well.

In an embodiment a), the housing, the electrodynamic actuator, the speaker and the electronic sound signal circuit can be part of a single acoustic device. That means that the acoustic system is embodied as a self-contained acoustic device, which contains all necessary components. For example, the acoustic output device can be embodied as a headphone, a headset, a hearing aid or a mobile phone. In the case of a mobile phone, the electrodynamic actuator may also acoustically be coupled to a display of the mobile phone. In such a case, the display is considered as being part of the housing of the acoustic system or acoustic device.

In an alternative embodiment b), the housing, the electrodynamic actuator and the speaker can be part of a sound emitting device and the electronic sound signal circuit can be part of a separate signal generation device,
wherein the signal generation device is designed to generate the actuator signal and the speaker signal and to transmit the actuator signal and the speaker signal to the sound emitting device and
wherein the sound emitting device is designed to receive the actuator signal and the speaker signal from the signal generation device and to emit the sound based on the actuator signal and the speaker signal.

That means that the acoustic system has a two part design with a signal generation device (where the signal forming takes place) and a sound emitting device (which finally emits the sound). For example, the transmission of the actuator signal and the speaker signal can be provided over air or by wire. Accordingly, the signal generation device and the sound emitting device may have interfaces for wired communication or for communication over air. For example, the sound emitting device can be embodied as a headphone, a headset or a hearing aid and the signal generation device can be embodied as a mobile phone, a tablet computer or a desktop computer.

### BRIEF DESCRIPTION OF THE DRAWINGS

These and other aspects, features, details, utilities, and advantages of the invention will become more fully apparent from the following detailed description, appended claims, and accompanying drawings, wherein the drawings illustrate features in accordance with exemplary embodiments of the invention, and wherein:

FIG. 1 shows a schematic view of an exemplary acoustic system or acoustic device on a user's head, of which only his ear is shown;

FIG. 2 shows a cross sectional view of the electrodynamic actuator and the speaker, which are connected to an electronic sound signal circuit;

FIG. 3 shows a detailed functional view of an electronic sound signal circuit;

FIG. 4 shows an example of filter curves for the actuator filter and the speaker filter which have high-pass and low-pass characteristics;

FIG. 5 shows an example of filter curves for the actuator filter and the speaker filter which have band-pass and band-stop characteristics;

FIG. 6 shows an exemplary filter curve for a privacy enhancement filter;

FIG. 7 shows a schematic view of an acoustic system or acoustic device with a separate audio source;

FIG. 8 shows a schematic view of a split acoustic system with a signal generation device and a separate sound emitting device;

FIG. 9 shows a more detailed view of a signal generation device and a sound emitting device;

FIG. 10 shows a cross sectional view of a combined actuator speaker device; and

FIG. 11 shows an exemplary diagram of the improvement of the signal to noise ratio over the ratio between the actuator signal and the speaker signal and over the phase shift for a particular frequency.

Like reference numbers refer to like or equivalent parts in the several views.

### DETAILED DESCRIPTION OF EMBODIMENTS

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It must be noted that, as used in this specification and the appended claims, the singular forms “a,” “an” and “the” include plural referents unless the content clearly dictates otherwise.

The terms “first,” “second,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

All directional references (e.g., “plus,” “minus,” “upper,” “lower,” “upward,” “down-ward,” “left,” “right,” “leftward,” “rightward,” “front,” “rear,” “top,” “bottom,” “over,” “under,” “above,” “below,” “vertical,” “horizontal,” “clockwise,” and “counterclockwise”) are only used for identification purposes to aid the reader's understanding of the present disclosure, and do not create limitations, particularly as to the position, orientation, or use of the any aspect of the disclosure. It is to be understood that the terms so used are interchangeable under appropriate circumstances such that the embodiments of the invention described herein are, for example, capable of operation in other orientations than those illustrated or otherwise described herein.

As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose.

Joinder references (e.g., “attached,” “coupled,” “connected,” and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

All numbers expressing measurements and so forth used in the specification and claims are to be understood as being modified in all instances by the term “about” or “substantially,” which particularly means a deviation of ±10% from a reference value.

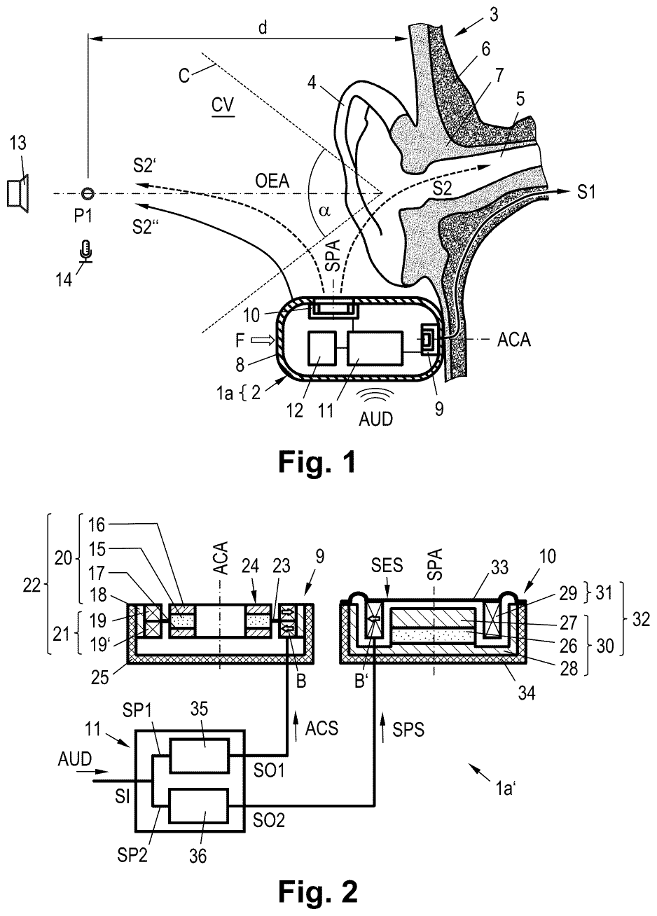

FIG. 1 shows a schematic view of an exemplary acoustic system 1a, which is embodied as a self-contained acoustic device 2 in this embodiment, and which is worn by a user 3, of whom only an ear 4 and a part of the ear channel 5 is shown in cross-sectional view. In more detail, bone tissue 6 and soft tissue 7 forming the ear 4 and a part of the ear channel 5 is depicted in FIG. 1.

The acoustic device 2 comprises a housing 8, an electrodynamic actuator 9, a speaker 10, an electronic sound signal circuit 11 and an optional battery 12. The housing 8 or at least a part of the housing 8 is pressed against the head of a user 3 in the region of his ear 4 for acoustic bone conduction. For example, a force F pressing the housing 8 against the user's head can be generated by a non-shown headband or boom of the acoustic device 2. In particular, the force F, with which the housing 8 is pressed against the user's head, can be in a range between 0.05 N and 5 N.

The electrodynamic actuator 9, which is shown in more detail in FIG. 2, is acoustically coupled to the housing 8 and designed to emit sound S1 to be transmitted primarily by bone conduction (structure-borne sound). The speaker 10, which is shown in more detail in FIG. 2 as well, is designed to emit sound S2 to be transmitted primarily by air conduction (airborne sound). In other words, sound is transmitted to the user 3 (strictly speaking to his middle ear and inner ear) by the electrodynamic actuator 9 via bone conduction and by the speaker 10 via air conduction as is illustrated in FIG. 1 by the arrows S1 and S2. In this way, the sound impression for the user 3 can be improved over simple bone conduction based devices, which may have unimpressive sound at certain frequency ranges.

Moreover, FIG. 1 shows an external sound source 13 and an external microphone 14, the use of which is explained later.

Reference is now made to FIG. 2, which shows another example of an acoustic system 1a′ in more detail. Concretely, FIG. 2 shows a cross sectional view of the electrodynamic actuator 9 and the speaker 10 and an electronic sound signal circuit 11 for driving the same.

The electrodynamic actuator 9 comprises an actuator center magnet 15, an actuator top plate 16, which is arranged on top of the actuator center magnet 15, an actuator bottom plate 17, which is arranged below the actuator center magnet 15 and an outer actuator ring 18, on which two actuator coils 19, 19′ are arranged. The actuator center magnet 15, the actuator top plate 16, the actuator bottom plate 17 and the outer actuator ring 18 together form an actuator magnet system 20. The two actuator coils 19, 19′ form an actuator coil arrangement 21. The actuator magnet system 20 and the actuator coil arrangement 21 together form an actuator motor 22. Between the inner magnetic arrangement, which is formed by the actuator center magnet 15, the actuator top plate 16 and the actuator bottom plate 17, and the actuator coil arrangement 21, a gap is formed, wherein the inner magnetic arrangement and the actuator coil arrangement 21 are movably connected to each other by means of spring legs 23. Finally, the electrodynamic actuator 9 can comprise an optional actuator housing or actuator frame 25, which the aforementioned components are built into.

The function of the electrodynamic actuator 9 is as follows:

The actuator center magnet 15 generates a magnetic field B, which is guided by the actuator top plate 16, the actuator bottom plate 17 and the outer actuator ring 18. For guiding the magnetic field B, the actuator top plate 16, the actuator bottom plate 17 and the outer actuator ring 18 can be made of a ferromagnetic material (e.g. soft iron). When an actuator signal ACS is fed to the actuator coils 19, 19′, a force acts on the inner magnetic arrangement and causes a movement of the same along the actuator axis ACA. Hence, this inner magnetic arrangement may also be seen as and termed as moving mass 24. The electronic sound signal circuit 11 generates the actuator signal ACS for driving the actuator motor 22 based on an audio input signal AUD so that the moving mass 24 moves according to the audio input signal AUD and in turn causes the housing 8 to vibrate according to the audio input signal AUD. Further on, because the housing 8 is acoustically coupled to the soft tissue 7 and the bone tissue 6, said vibration is transmitted as bone conducted sound S1 to the user's middle ear and inner ear. It should be noted that the electrodynamic actuator 9 is just exemplary and shown in detail just for illustrative purposes. It can, without deviating from the principal function of the acoustic system 1a′, also have another structure or design.

The speaker 10 comprises a speaker center magnet 26, a speaker top plate 27, which is arranged on top of the speaker center magnet 26 and a speaker pot 28, in which the speaker center magnet 26 and the speaker top plate 27 are arranged. In a gap, which is formed between the speaker top plate 27 and the speaker pot 28, a speaker coil 29 is arranged. The speaker center magnet 26, the speaker top plate 27 and the speaker pot 28 together form a speaker magnet system 30. The speaker coil 29 forms a speaker coil arrangement 31. The speaker magnet system 30 and the speaker coil arrangement 31 together form a speaker motor 32. The speaker magnet system 30 and the speaker coil arrangement 31 are movably connected to each other by a membrane 33. Finally, the speaker 10 can comprise an optional speaker housing or speaker frame 34, which the aforementioned components are built into.

The function of the speaker 10 is as follows:

The center magnet 26 generates a magnetic field B′, which is guided by the speaker top plate 27 and the speaker pot 28. For guiding the magnetic field B′, the speaker top plate 27 and the speaker pot 28 can be made of a ferromagnetic material (e.g. soft iron). When a speaker signal SPS is fed to the speaker coil 29, a force acts on the speaker coil 29 and causes a movement of the same along the speaker axis SPA. The electronic sound signal circuit 11 generates the speaker signal SPS for driving the speaker motor 32 based on the audio input signal AUD so that the membrane 33 moves according to the audio input signal AUD. As a consequence, sound S2 is emitted from the sound emitting surface SES and in turn is transmitted to the user's middle ear and inner ear. It should be noted that the speaker 10 is just exemplary and shown in detail just for illustrative purposes. It can, without deviating from the principal function of the acoustic system 1a′, also have another structure or design.

So, in general words, the electrodynamic actuator 9 comprises an actuator motor 22 and a moving mass 24 driven by the actuator motor 22 or formed by a part of the actuator motor 22, wherein the electrodynamic actuator 9 is acoustically coupled to the housing 8 and designed to emit sound S1 to be transmitted primarily by bone conduction. The speaker 10 comprises a speaker motor 32 and a membrane 33 driven by the speaker motor 32, wherein the speaker 10 is designed to emit sound S2 to be transmitted primarily by air conduction.

While bone conduction generally shall avoid disturbance to people in the vicinity of the user 3 and shall ensure privacy for the user 3, in reality, sound S2′ originating from the speaker 10 (airborne sound) and also sound S2″ originating from the electrodynamic actuator 9 (as structure-borne sound through housing 8 and then via air conduction) unintendedly is emitted into the vicinity of the user 3. The latter is caused by unintended excitation of the housing 8 offside of the user's ear 4. On the one hand, people in the vicinity of the user 3 could be disturbed by that sound S2′, S2″, and on the other hand, this sound emission causes privacy issues because those people could hear private or even confidential information, which intendedly is only directed to the user 3.

To overcome this problem, the electronic sound signal circuit 11 generates the actuator signal ACS for driving the actuator motor 22 and the speaker signal SPS for driving the speaker motor 32 based on the audio input signal AUD in a way that in an offside location P1 offside of the user 3, offside sound S2′, S2″ transmitted over air including sound S2″ transmitted over air originating from the electrodynamic actuator 9 (which excites the housing 8) is less loud than in a state, in which the speaker 10 is turned off. In other words, in the offside location P1 offside of the user 3, sound S2″ transmitted over air originating from the electrodynamic actuator 9 is cancelled or at least reduced or suppressed by the sound S2′ transmitted over air originating from the speaker 10.

For this reason, the electronic sound signal circuit 11 can comprise an actuator signal processing unit 35 for generating the actuator signal ACS, which is arranged in an actuator signal path SP1 of the electronic sound signal circuit 11, and a speaker signal processing unit 36 for generating the speaker signal SPS, which is arranged in a speaker signal path SP2 of the electronic sound signal circuit 11, as depicted in FIG. 2. In detail, the audio input signal AUD is fed to an audio input SI of the electronic sound signal circuit 11, the actuator signal ACS is provided at an actuator sound output SO1 of the electronic sound signal circuit 11 and the speaker signal SPS is provided at a speaker sound output SO2 of the electronic sound signal circuit 11.

Usually, one would think that it gets louder in the offside location P1 when the speaker 10 is turned on, but the opposite is true here. The reason is that the electronic sound signal circuit 11, in detail its actuator signal processing unit 35 and its speaker signal processing unit 36, sets the signal levels of the actuator signal ACS and the speaker signal SPS and a phase shift between the actuator signal ACS and the speaker signal SPS in a way that the aforementioned sound cancellation or sound suppression is provided.

The above is at least true in a part of the audible frequency range. It should also be noted that there could be locations offside of the user's ear 4, where the above definition is not true. It should also be noted that the above definition is meant under the condition that the power of the actuator signal ACS remains unchanged when the speaker 10 is turned on and off.

In the context of the sound emitting surface SES, one should additionally note that sound S2, S2′ can also emanate from the backside of the membrane 33. However, this backside faces an interior space of the acoustic device 2. Hence, the membrane 33 may be considered to have the main sound emitting surface SES and a secondary sound emitting surface (i.e. said backside). Sound S2 emanated by the main sound emitting surface SES directly reaches the user's ear 4, whereas sound S2 emanated by the secondary sound emitting surface does not directly reach the user's ear 4, but only indirectly via reflection or excitation of the housing 8. However, in view of the electrodynamic actuator 9, such indirect sound is negligible.

It can get complicated to do sound suppression in the whole space around the user 3. To ease the provision of sound suppression, the sound suppression can be limited to particular ranges.

For example, a distance d between the offside location P1 (or a plurality of offside locations P1, at which sound suppression is done) and the user's ear 4, at which the housing 8 contacts the user 3, can be in a range between 20 cm and 100 cm, in particular in a range between 40 cm and 80 cm. Hence, the sound suppression is limited to a distance range, in which violation of privacy is considered to be principally possible. It is unlikely that people can get closer than 20 cm (or 40 cm) without causing the user's attention, and it is unlikely that the offside sound S2′, S2″ is loud enough in a distance range over 100 cm (or 80 cm) to be clearly audible by people other than the user 3. However, that does not mean that sound suppression cannot also occur in locations out of the given distance range. So, within the given distance range, sound suppression can be considered and termed as “nominal sound suppression,” whereas sound suppression out of the given distance range can be considered and termed as “incidental sound suppression.”

In another embodiment, the offside location P1 (or a plurality of offside locations P1, at which sound suppression is done) can be arranged on an off-ear axis OEA, which is a horizontal axis perpendicular to a viewing direction of the user 3 starting at an ear canal 5 of the user 3. Hence, the sound suppression is limited to off-ear axis OEA, what however does not mean that sound suppression cannot also occur in locations offside of the off-ear axis OEA. Again, a distinction can be made between nominal and incidental sound suppression.

In yet another embodiment, the offside location P1 (or a plurality of offside locations P1, at which sound suppression is done) can be arranged in a cone volume CV of a (virtual) cone C, which opens from a user's ear 4, at which the housing 8 contacts the user 3 for bone conduction, wherein the cone C opens at an angle α of 120° with respect to an the off-ear axis OEA. Hence, the sound suppression is limited to the cone volume CV, what again however does not mean that sound suppression cannot also occur in locations offside of the cone volume CV. Again, a distinction can be made between nominal and incidental sound suppression.

In the above embodiments, sound suppression particularly can occur in all offside locations P1 in the given distance range, on the off-ear axis OEA or in the cone volume CV. However, to ease sound suppression, a limitation of the (nominal) sound suppression can be made. For example, the (nominal) sound suppression can be related to (only) at least 80% of all offside locations P1 in the given distance range, on the off-ear axis OEA or in the cone volume CV.

Generally, sound suppression can also be related to an average tuning parameter (e.g. sound suppression, improvement of signal to noise ratio and so on) in the offside location(s) P1. Here, the average tuning parameter is taken into consideration in the offside locations P1 in the given distance range, on the off-ear axis OEA or in the cone volume CV. This embodiment reflects the fact that a dedicated sound suppression in a particular location P1 or in particular locations P1 in reality is not that relevant for ensuring privacy, but sound suppression in a particular space or volume is more relevant. Accordingly, the average tuning parameter is taken as a measure in this embodiment what means, that a very good sound suppression in one location P1 can compensate for a worse sound suppression in another location P1.

It should also be noted that the aforementioned embodiments can be combined in any desired manner. For example, the offside locations P1 can be arranged on the off-ear axis OEA in the given distance range, or in the cone volume CV in the given distance range. The latter means that the offside locations P1 are arranged in a frustum of a (virtual) cone C then.

In particular, the electronic sound signal circuit 11 can be designed to cause a sound suppression in the offside location P1 in the on-state of the speaker 10 in relation to the off-state of the speaker 10 at a loudness of 75 dB perceived by the user 3 and/or for a sinusoidal audio input signal AUD at a frequency of 3 kHz. These values can particularly be considered as “nominal” tuning or measuring conditions.

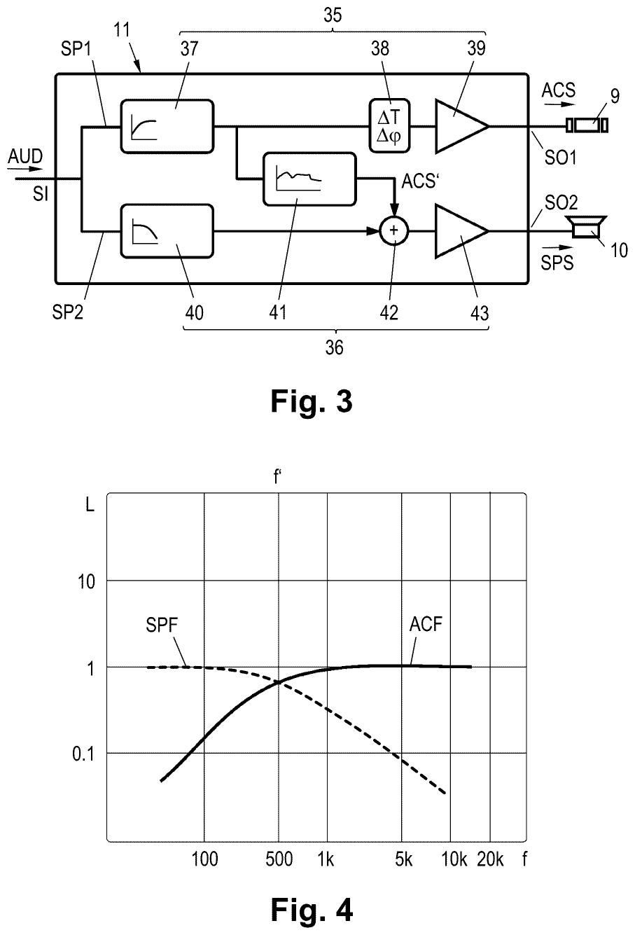

FIG. 3 now shows a more detailed schematic view of an exemplary electronic sound signal circuit 11. The electronic sound signal circuit 11 again comprises
an audio input SI being designed to receive the audio input signal AUD,
an actuator sound output SO1, which is connected to the actuator motor 22,
a speaker sound output SO2, which is connected to the speaker motor 32,
an actuator signal path SP1 between the audio input SI and the actuator sound output SO1 and a speaker signal path SP2 between the audio input signal AUD and the speaker sound output SO2,
an actuator signal processing unit 35, which is arranged in the actuator signal path SP1 and which is designed to generate the actuator signal ACS based on the audio input signal AUD and to feed the actuator signal ACS to the actuator sound output SO1, and
a speaker signal processing unit 36, which is arranged in the speaker signal path SP2 and which is designed to generate the speaker signal SPS based on the audio input signal AUD and to feed the speaker signal SPS to speaker sound output SO2.

In more detail, in this embodiment, the actuator signal processing unit 35 comprises an actuator filter 37 (which filters the audio input signal AUD), a delaying unit or phase shifting unit 38 and an actuator amplification stage 39. Moreover, the speaker signal processing unit 36, in this embodiment, comprises a speaker filter 40 (which filters the audio input signal AUD, too), a privacy enhancement filter 41, a summing unit 42 and speaker amplification stage 43. The delaying or phase shifting unit 38 provides a delay time ΔT or phase shift Δφ between the actuator signal ACS and the speaker signal SPS and is arranged in the actuator signal path SP1 like it is the case in FIG. 3 or can alternatively be arranged in the speaker signal path SP2. The actuator amplification stage 39 amplifies the output signal of the actuator filter 37 and the speaker amplification stage 43 amplifies an output signal of the speaker filter 40.

It should be noted that the design of the electronic sound signal circuit 11 is just exemplary and other designs are possible as well. In particular, the amplification stages 39, 43 can be arranged out of the electronic sound signal circuit 11. Even more, the electronic sound signal circuit 11 depicted in FIG. 3 may be seen as a (pure) functional representation of a special embodiment, which not necessarily is reflected in the physic electronic sound signal circuit 11 one by one. In FIG. 3, the function of the sound suppression (mainly) is integrated in the privacy enhancement filter 41, whereas providing a satisfying sound impression for the user 3 (mainly) is integrated in the actuator filter 37 and the speaker filter 40. However, the crosslinking of the actuator signal path SP1 and the speaker signal path SP2, which is provided by the privacy enhancement filter 41, can be missing in a real electronic sound signal circuit 11. Instead, the privacy enhancement filter 41 can be an integral part of the speaker filter 40. In such a case, the privacy enhancement filter 41 and the summing unit 42 can be missing in a real the electronic sound signal circuit 11. In this way, a very compact design of the electronic sound signal circuit 11 can be obtained.

As can be envisaged from FIGS. 2 and 3, the electronic sound signal circuit 11 is designed to mix both sound S1 originating from the electrodynamic actuator 9, which primarily is transmitted by bone conduction, and sound S2 originating from the speaker 10, which primarily is transmitted by air conduction. On the one hand, this is done for a satisfying hearing perception of the user 3, on the other hand, for the provision of privacy. In particular, a share of the hearing perception of the user 3 formed by sound S1 originating from the electrodynamic actuator 9 and a remaining share of the hearing perception of the user 3 formed by sound S2 originating from the speaker 10 and hence a ratio between the actuator signal ACS and the speaker signal SPS may vary over the frequency f of the sound S1, S2 or the audio input signal AUD respectively. The same counts for a phase shift Δφ between the sound S1 and S2 and hence between the actuator signal ACS and the speaker signal SPS. In other words, the phase shift Δφ may vary over the frequency f of the sound S1, S2 or the audio input signal AUD as well.

The delay time ΔT or phase shift Δφ particularly can be used to compensate a group delay time of the privacy enhancement filter 41. Accordingly, the actuator signal ACS can be delayed so that it is output in time with the speaker signal SPS despite a delay caused by the privacy enhancement filter 41. The group delay time of a filter is not constant so that a phase shift Δφ may be used. In one embodiment, an all-pass filter with a constant (magnitude) transfer function=1 and a desired phase response can be used. However, one should note that the delay time ΔT or phase shift Δφ is not limited to the aforementioned functions but can also involve a delay time ΔT or phase shift Δφ needed for sound suppression or for a satisfying signal to noise ratio. Generally, such a delay time ΔT or phase shift Δφ mainly depends on the different characteristics of the different transmission paths, i.e. on the different characteristics of bone conduction vs. air conduction. It should be noted that depending on the position of the speaker 10 and the wiring of the speaker 10, a delay time ΔT or phase shift Δφ may be dispensable.

In one embodiment, the share formed by the sound S1 originating from the electrodynamic actuator 9 (or the actuator signal ACS respectively) is higher than the remaining share formed by the sound S2 originating from the speaker 10 (or the speaker signal SPS respectively) above a cutoff frequency f. Accordingly, the actuator filter 37 can have a high-pass characteristics and/or the speaker filter 40 can have a low-pass characteristics. In this context, FIG. 4 shows an exemplary actuator filter curve ACF and an exemplary speaker filter curve SPF in a diagram, which shows the signal level L over the frequency f.

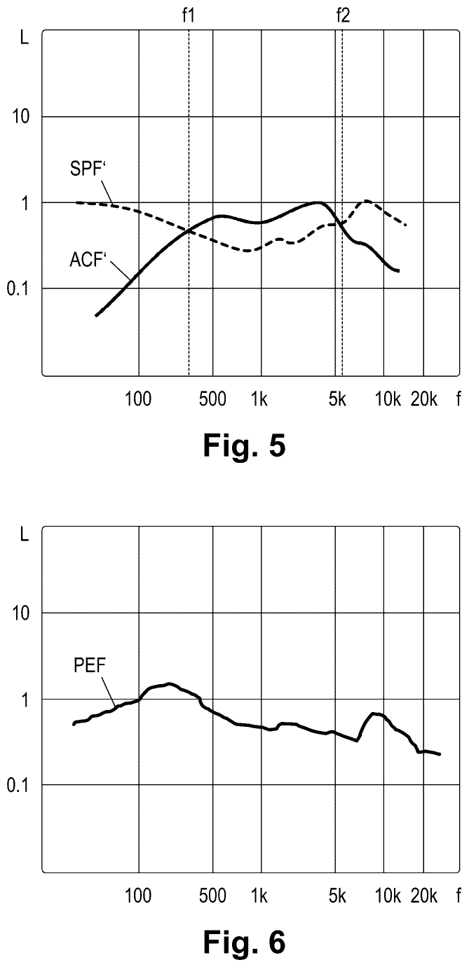

Alternatively, the share formed by the sound S1 originating from the electrodynamic actuator 9 (or the actuator signal ACS respectively) is higher than the remaining share formed by the sound S2 originating from the speaker 10 (or the speaker signal SPS respectively) above a first frequency f1 and below a higher second frequency f2. Accordingly, the actuator filter 37 can have a band-pass characteristics and/or the speaker filter 40 can have a band-stop characteristics. In this context, FIG. 5 shows an exemplary actuator filter curve ACF′ and an exemplary speaker filter curve SPF′ in a diagram, which again shows the signal level L over the frequency f.

FIG. 6, in addition shows an exemplary privacy enhancement filter curve PEF, which can be obtained in a tuning procedure, which is explained later.

Generally, the acoustic system 1a, 1a′ can be embodied in a way that the housing 8, the electrodynamic actuator 9, the speaker 10 and the electronic sound signal circuit 11 are part of a single acoustic device 2 like this is already shown in FIG. 1. That means that the acoustic system 1a, 1a′ can be embodied as a self-contained acoustic device 2, which contains all necessary components. For example, the acoustic device 2 can be embodied as a headphone, a headset, a hearing aid or a mobile phone. In the case of a mobile phone, the electrodynamic actuator 9 may also acoustically be coupled to a display of the mobile phone. In such a case, the display can also be considered as being part of the housing 8 of the acoustic system 1a, 1a′ or the acoustic device 2.

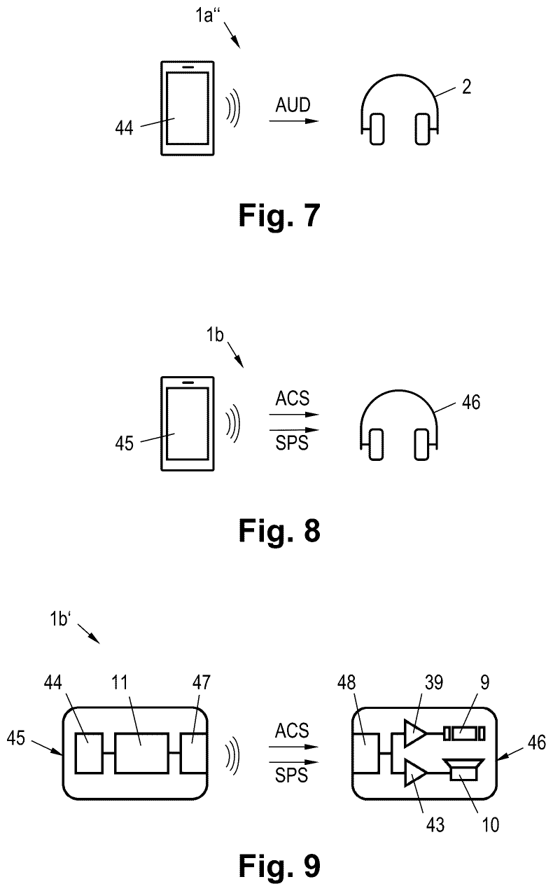

As a supplementation, FIG. 7 shows an acoustic system 1a″, where the acoustic device 2 is embodied as a headphone and where the audio input signal AUD is provided by a (standard) mobile phone, which forms an audio source 44 here. That means, that the audio source 44 or mobile phone transmits an audio input signal AUD (e.g. music or voice) to the headphone via air, wherein the headphone transforms the audio input signal AUD into audible sound as already explained hereinbefore.

However, this is not the only possibility, and FIG. 8 shows an alternative embodiment, where the housing 8, the electrodynamic actuator 9 and the speaker 10 are part of a sound emitting device 46 and the electronic sound signal circuit 11 is part of a separate signal generation device 45. The signal generation device 45 generates the actuator signal ACS and the speaker signal SPS and transmits the same to the sound emitting device 46. The sound emitting device 46 receives the actuator signal ACS and the speaker signal SPS from the signal generation device 45 and emits the sound S1, S2, S2′ based on the actuator signal ACS and the speaker signal SPS. That means that the acoustic system 1b of FIG. 8 has a two part or split design with a signal generation device 45 (where the signal forming takes place) and a sound emitting device 46 (which finally emits the sound). For example, the transmission of the actuator signal ACS and the speaker signal SPS can be provided over air or by wire. For example, the sound emitting device 46 can be embodied as a headphone (like it is the case in FIG. 8), a headset or a hearing aid and the signal generation device can be embodied as a mobile phone (like it is the case in FIG. 8), a tablet computer or a desktop computer.

FIG. 9 now shows a more detailed schematic view of a two part or split acoustic system 1b′. In detail, the signal generation device 45 comprises an audio source 44, the electronic sound signal circuit 11 and a sender 47 for communication over air. The sound emitting device 46 comprises a receiver 48 for communication over air, an actuator amplification stage 39 and a speaker amplification stage 43 as well as an electrodynamic actuator 9 and the speaker 10 connected thereto. FIG. 9 particularly shows that the generation of the actuator signal ACS and the speaker signal SPS is done in the signal generation device 45 (and not in the sound emitting device 46).

It should be noted at this point that communication over air is not necessary in the embodiments shown in the FIGS. 7 to 9. Instead, the audio source 44 and the headphone 2 or the signal generation device 45 and the sound emitting device 46 respectively may have interfaces for wired communication.

Generally, the electronic sound signal circuit 11 does not need to generate the actuator signal ACS and the speaker signal SPS “on the fly.” In contrast, an audio input signal AUD may be processed by the electronic sound signal circuit 11 and may be stored for later use. In such a case, a stored and already processed audio file can be “streamed” to the electrodynamic actuator 9 and to the speaker 10 without being processed in the given way once more. However, that does not exclude further processing of the audio file in another way. For example, the audio stream may pass an equalizer, by which the user 3 can adjust the audio output to his personal demands, before it is output via the electrodynamic actuator 9 and the speaker 10. It should be noted that these considerations are not limited to a particular embodiment but relate to all kinds of acoustic systems 1a . . . 1b′.

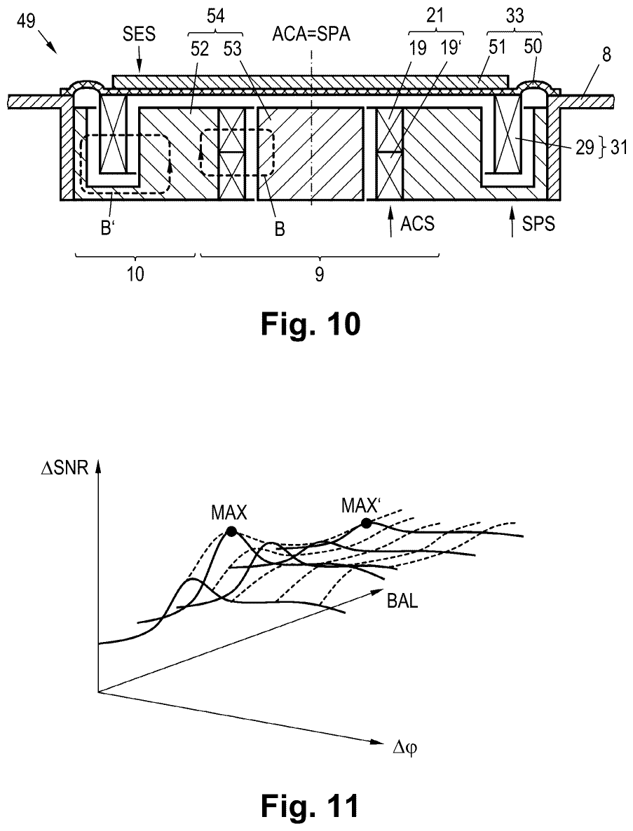

The electrodynamic actuator 9 and the speaker 10 can be embodied as a combined actuator speaker device 49 like this is depicted in FIG. 10. Here, the combined actuator speaker device 49 has an inner actuator coil arrangement 21 and an outer speaker coil arrangement 31. Moreover, the membrane 33 comprises a flexible membrane part 50 and an optional rigid membrane part 51 connected thereto. Moreover, the combined actuator speaker device 49 comprises an outer magnet system part 52 and an inner magnet system part 53, which together form or are part of a common magnet system 54. The design of such a combined actuator speaker device 49 is known in principle and hence not explained in more detail. However, as can be envisaged, the combined actuator speaker device 49 allows for very compact designs. In particular, the actuator axis ACA and the speaker axis SPA coincide this embodiment.

At this point, one should note that it is beneficial if the actuator axis ACA, along which the actuator motor 22 moves, and the speaker axis SPA, along which the speaker motor 32 moves, are turned against each other by 90° like this is shown in FIG. 1. In such an embodiment, the moving mass 24 of the electrodynamic actuator 9 and the moving mass of the speaker 10 are more or less decoupled what may ease tuning of the acoustic system 1a . . . 1b′. However, the actuator axis ACA and the speaker axis SPA can also be parallel to each other (see also FIG. 2 in this context). In this case and also in case of coinciding axes ACA, SPA (see FIG. 9) the moving mass of the speaker 10 directly may influence the vibration caused by the electrodynamic actuator 9 what may be advantageous under certain conditions.

A method of tuning an acoustic system 1a . . . 1b′ can comprise the following steps:
applying an audio input signal AUD to the acoustic system 1a . . . 1b′,
measuring offside sound S2′, S2″ generated by the acoustic system 1a . . . 1b′ in an offside location P1 offside of the user 3 or offside an equivalent arrangement of the acoustic system 1a . . . 1b′ on a user model,
setting a ratio between the actuator signal ACS and the speaker signal SPS and a phase shift Δφ between the actuator signal ACS and the speaker signal SPS in a way that offside sound S2′, S2″ transmitted over air in said offside location P1 is less loud than in a state, in which the speaker 10 is turned off (and even reaches a minimum), and
setting the chosen ratio and the chosen phase shift Δφ in the electronic sound signal circuit 11.

Tuning can be done in a number of ways. For example, a sound suppression in the offside location P1 offside of the user 3 caused in the on-state of the speaker 10 in relation to a state, in which the speaker 10 is turned off
can be at least 6 dB and/or
can reach (at least a local or even a global) maximum in view of a change of a ratio BAL between the actuator signal ACS and the speaker signal SPS or in view of a change of a phase shift Δφ between the actuator signal ACS and the speaker signal SPS.

The second variant means, that a change of the ratio BAL or the phase shift Δφ between the actuator signal ACS and the speaker signal SPS leads to a reduction of the sound suppression and accordingly to a worse sound suppression (see also FIG. 11 in this context). It should also be noted that the aforementioned conditions can be used in combination. For example, this can mean that in the offside location P1 a maximum of sound suppression of at least 6 dB shall be achieved.

For explanation of measuring the sound reduction or sound suppression in the offside location P1, reference is made again to FIG. 1, in particular to the external microphone 14, which is placed in said offside location P1 (it should be noted that in FIG. 1, to avoid confusion, the external microphone 14 is drawn near the offside location P1. However, in reality, the external microphone 14 is placed in the offside location P1). By measuring the sound pressure level in the on-state and in the off-state of the speaker 10, the ratio between suppressed sound pressure level and non-suppressed sound pressure level can be determined. It should be noted that the electrodynamic actuator 9 continues to output sound while the speaker 10 is deactivated, and it should also be noted that preferably a sine tone of a certain frequency f is used for the measurement. The determination of the sound suppression can be done for a number of different frequencies f, so that the sound suppression can be determined over a particular frequency range.

In an alternative embodiment, the sound suppression can be related to the power consumption of the electrodynamic actuator 9 and the speaker 10, or in other words, the ratio between the sound suppression and said power consumption can be taken as a measure. Accordingly, in such a case, at a loudness of 75 dB perceived by the user, in the offside location Ploffside of the user 3, preferably

$${K}_{1} = \frac{S S U P}{{P}_{ACS} + {P}_{S P S}} > 10 {W}^{- 1}$$

and/or
the parameter K₁ reaches (at least a local or even a global) maximum in view of a change of a ratio BAL between the actuator signal ACS and the speaker signal SPS or in view of a change of a phase shift Δφ between the actuator signal ACS and the speaker signal SPS.

Here, P_{ACS} is an electric power of the actuator signal ACS, P_{SPS} is an electric power of the speaker signal SPS and SSUP is a sound suppression caused by the speaker 10 in the offside location P1 in relation to the speaker 10 being turned off. By taking the power consumption of the electrodynamic actuator 9 and the speaker 10 as a measure, settings, where a high sound suppression SSUP is obtained at the cost of an (unfavorable) high power consumption P_{ACS}+P_{SPS}, are avoided. It should also be noted that the aforementioned conditions can be used in combination. For example, this can mean that in the offside location P1 a maximum for the parameter K₁ of at least 10 W⁻¹ shall be achieved.

In another embodiment, the sound suppression can be multiplied with the ratio between the actuator power and the total power consumption of the electrodynamic actuator 9 and the speaker 10. Accordingly, in such a case, in the offside location P1 offside of the user 3, preferably

$${K}_{2} = \frac{{P}_{A C S}}{{P}_{A C S} + {P}_{S P S}} \cdot SSUP > 1.3$$

and/or
the parameter K₂ reaches (at least a local or even a global) maximum in view of a change of a ratio BAL between the actuator signal ACS and the speaker signal SPS or in view of a change of a phase shift Δφ between the actuator signal ACS and the speaker signal SPS,
wherein P_{ACS} is an electric power of the actuator signal, P_{SPS} is an electric power of the speaker signal and SSUP is a sound suppression caused by the speaker 10 in the offside location P1 in relation to the speaker 10 being turned off.

By taking the relative power consumption of the electrodynamic actuator 9 as a measure, settings, where a high sound suppression SSUP is obtained at the cost of an (unfavorable) high power consumption of the electrodynamic actuator 9, are avoided. It should also be noted that the aforementioned conditions can be used in combination. For example, this can mean that in the offside location P1 a maximum for the parameter K2 of at least 1.3 shall be achieved.

In another embodiment, an improvement of a signal to noise ratio ΔSNR between a loudness of the sound S1, S2 perceived by the user 3 or a user model and a sound pressure level of the offside sound S2′, S2″ in said offside location P1 offside of the user 3 caused in the on-state of the speaker 10 in relation to a state, in which the speaker 10 is turned off
can be at least 6 dB and/or
can reach (at least a local or even a global) maximum in view of a change of a ratio BAL between the actuator signal ACS and the speaker signal SPS or in view of a change of a phase shift Δφ between the actuator signal ACS and the speaker signal SPS.

The second variant means, that a change of the ratio BAL or the phase shift Δφ between the actuator signal ACS and the speaker signal SPS leads to a reduction of the improvement of the signal to noise ratio ΔSNR and accordingly to a worse improvement. It should also be noted that the aforementioned conditions can be used in combination. For example, this can mean that in the offside location P1 a maximum of the improvement of the signal to noise ratio ΔSNR of at least 6 dB shall be achieved.

For explanation of the determination of the signal to noise ratio, reference is made again to FIG. 1, in particular to the external sound source 13 and the external microphone 14. It should be noted that sound S1, S2 reaching the user 3 is considered as “signal” and sound S2′, S2″ offside of the user 3 and in particular in the offside location P1 is considered as “noise” for the following considerations.

For determining the signal to noise ratio, in a first step, the “signal” level (which may also considered as “reference level”) is measured. For this reason, the user 3 adjusts the output level or volume of the acoustic system 1a . . . 1b′ so as to perceive the sound generated by the external sound source 13 and the sound produced by the acoustic system 1a . . . 1b′ as equally loud. For a proper measurement, sound output may be toggled between the external sound source 13 and the acoustic system 1a . . . 1b′. The external microphone 14 is placed close to the user's ear 4 or even in the ear channel 5 for this measurement and measures the sound pressure level of the “signal.”

In a second step, the external sound source 13 is switched off, and offside sound S2′, S2″ caused by the acoustic system 1a . . . 1b′ is measured now by the external microphone 14. For this reason, the external microphone 14 is placed in the offside location P1 (again it should be noted that in FIG. 1, to avoid confusion, the external microphone 14 is drawn nearby the offside location P1, but in reality, the external microphone 14 is placed in the offside location P1) and measures the sound pressure level of the “noise.”

By dividing the results of both measurements, the signal to noise ratio can be calculated. It should be noted that the audio input signal AUD shall be the same for the external sound source 13 and the acoustic system 1a . . . 1b′ in both measuring steps and can be a sine tone with a certain frequency f. The determination of the signal to noise ratio can be done for a number of different frequencies f, so that signal to noise ratio can be determined over a particular frequency range.

The improvement of the signal to noise ratio ΔSNR is the change of the signal to noise ratio in the on-state of the speaker 10 compared to the off-state of the speaker 10. According to the proposed measures, the signal to noise ratio gets better (higher) when the speaker 10 is turned on.

By setting proper values for the signal levels of the actuator signal ACS and the speaker signal SPS and for the phase shift Δφ between the actuator signal ACS and the speaker signal SPS in the electronic sound signal circuit 11, both sound suppression and the signal to noise ratio can be influenced. By tuning the electronic sound signal circuit 11 properly, both a satisfying sound suppression and a satisfying signal to noise ratio can be achieved or provided.

In an alternative embodiment, the improvement of the signal to noise ratio ΔSNR can be related to the power consumption of the electrodynamic actuator 9 and the speaker 10, or in other words, the ratio between said improvement and said power consumption can be taken as a measure. Accordingly, in such a case, at a loudness of 75 dB perceived by the user 3, in the offside location offside of the user 3, preferably

$${K}_{3} = \frac{Δ S N R}{{P}_{ACS} + {P}_{S P S}} > 10 {W}^{- 1}$$

and/or
the parameter K₃ reaches (at least a local or even a global) maximum in view of a change of a ratio BAL between the actuator signal ACS and the speaker signal SPS or in view of a change of a phase shift Δφ between the actuator signal ACS and the speaker signal SPS.

Here P_{ACS} is an electric power of the actuator signal ACS, P_{SPS} is an electric power of the speaker signal SPS and ΔSNR is an improvement of a signal to noise ratio between a loudness of the sound S1, S2 perceived by the user 3 or a user model and a sound pressure level of the offside sound S2′, S2″ in said offside location P1 caused in the on-state of the speaker 10 in relation to a state, in which the speaker 10 is turned off. By taking the power consumption of the electrodynamic actuator 9 and the speaker 10 as a measure, settings, where a high improvement of a signal to noise ratio ΔSNR is obtained at the cost of an (unfavorable) high power consumption P_{ACS}+P_{SPS}, are avoided. It should also be noted that the aforementioned conditions can be used in combination. For example, this can mean that in the offside location P1 a maximum for the parameter K₃ of at least 10 W⁻¹ shall be achieved.

In another embodiment, the improvement of the signal to noise ratio ΔSNR can be multiplied with the ratio between the actuator power and the total power consumption of the electrodynamic actuator 9 and the speaker 10. Accordingly, in such a case, in the offside location P1 offside of the user 3, preferably

$${K}_{4} = \frac{{P}_{A C S}}{{P}_{A C S} + {P}_{S P S}} \cdot Δ SNR > 1.3$$

and/or
the parameter K₄ reaches (at least a local or even a global) maximum in view of a change of a ratio BAL between the actuator signal ACS and the speaker signal SPS or in view of a change of a phase shift Δφ between the actuator signal ACS and the speaker signal SPS.

Here, P_{ACS} is an electric power of the actuator signal ACS, P_{SPS} is an electric power of the speaker signal SPS and ΔSNR is an improvement of a signal to noise ratio between a loudness of the sound S1, S2 perceived by the user 3 or a user model and a sound pressure level of the offside sound S2′, S2″ in said offside location P1 caused in the on-state of the speaker 10 in relation to a state, in which the speaker 10 is turned off. By taking the relative power consumption of the electrodynamic actuator 9 as a measure, settings, where a high improvement of the signal to noise ratio ΔSNR is obtained at the cost of an (unfavorable) high power consumption of the electrodynamic actuator 9, are avoided. It should also be noted that the aforementioned conditions can be used in combination. For example, this can mean that in the offside location P1 a maximum for the parameter K₄ of at least 1.3 shall be achieved.

In yet another alternative embodiment, the aforementioned measures can be combined. Accordingly, in such a case, at a loudness of 75 dB perceived by the user 3, in the offside location P1 offside of the user 3, preferably

$${K}_{5} = \frac{S SUP \cdot Δ SNR}{{P}_{ACS} + {P}_{S P S}} > 20 {W}^{- 1}$$

and/or
the parameter K₅ reaches (at least a local or even a global) maximum in view of a change of a ratio BAL between the actuator signal ACS and the speaker signal SPS or in view of a change of a phase shift Δφ between the actuator signal ACS and the speaker signal SPS,
wherein P_{ACS} is an electric power of the actuator signal ACS, P_{SPS} is an electric power of the speaker signal SPS, SSUP is a sound suppression caused by the speaker 10 in the offside location P1 in relation to the speaker 10 being turned off and ΔSNR is an improvement of a signal to noise ratio between a loudness of the sound S1, S2 perceived by the user 3 or a user model and a sound pressure level of the offside sound S2′, S2″ in said offside location P1 caused in the on-state of the speaker 10 in relation to a state, in which the speaker 10 is turned off. Again settings, where sound suppression is done at the cost of an (unfavorable) high power consumption P_{ACS}+P_{SPS}, are avoided. It should also be noted that the aforementioned conditions can be used in combination. For example, this can mean that in the offside location P1 a maximum for the parameter K₅ of at least 20 W⁴ shall be achieved.

Generally, the aforementioned conditions and equations can also be related to the (absolute) signal to noise ratio instead of the improvement of the same. In other words, the (absolute) signal to noise ratio can be used in the aforementioned conditions and equations instead of the improvement of the signal to noise ratio ΔSNR.

Accordingly, a signal to noise ratio between a loudness of the sound S1, S2 perceived by the user 3 or a user model and a sound pressure level of the offside sound S2′, S2″ in said offside location P1 offside of the user 3,
can be at least 20 dB and/or
can reach (at least a local or even a global) maximum in view of a change of a ratio BAL between the actuator signal ACS and the speaker signal SPS or in view of a change of a phase shift Δφ between the actuator signal ACS and the speaker signal SPS.

Further on, it is beneficial
if at a loudness of 75 dB perceived by the user 3, in the offside location P1 offside of the user 3,

$${K}_{6} = \frac{S N R}{{P}_{A C S} + {P}_{S P S}} > 50 {W}^{- 1}$$

and/or
if in the offside location P1 offside of the user 3,

$${K}_{7} = \frac{{P}_{A C S}}{{P}_{A C S} + {P}_{S P S}} \cdot SNR > 6.5$$

and/or
if at a loudness of 75 dB perceived by the user 3, in the offside location P1 offside of the user 3,

$${K}_{8} = \frac{S SUP \cdot SNR}{{P}_{A C S} + {P}_{SPS}} > 100 {W}^{- 1}$$

and/or
if the given one of the parameters K₆ . . . K₈ reaches (at least a local or even a global) maximum in view of a change of a ratio BAL between the actuator signal ACS and the speaker signal SPS or in view of a change of a phase shift Δφ between the actuator signal ACS and the speaker signal SPS,
wherein in all cases, P_{ACS} is an electric power of the actuator signal ACS, P_{SPS} is an electric power of the speaker signal SPS, SSUP is a sound suppression caused by the speaker 10 in the offside location P1 in relation to the speaker 10 being turned off and SNR is a signal to noise ratio between a loudness of the sound S1, S2 perceived by the user 3 or a user model and a sound pressure level of the offside sound S2′, S2″ in said offside location P1.

FIG. 11 in the aforementioned context shows an exemplary diagram of the improvement of the signal to noise ratio ΔSNR over the ratio BAL between the actuator signal and the speaker signal and over the phase shift Δφ for a particular frequency f (and for a particular total power of the electrodynamic actuator 9 and the speaker 10 or for a particular loudness perceived by the user 3). As can be seen, the exemplary function has an absolute maximum MAX and one further local maximum MAX′. So, tuning in this particular case can mean setting the ratio BAL between the actuator signal and the speaker signal and the phase shift Δφ in the electronic sound signal circuit 11 according to the absolute maximum MAX or the local maximum MAX′. Of course, a function of the given kind can also have a plurality of local maxima MAX′. Further on, diagrams according to FIG. 11 can be generated and drawn for a number of frequencies f, so that maxima MAX, MAX′ over a given frequency range can be found. It should also be noted that deviating from a maximum MAX, MAX′ is possible if other considerations are prioritized. Further on, further diagrams for varying total power of the electrodynamic actuator 9 and the speaker 10 and for a particular loudness can be generated. Concluding, a number of diagrams may be generated within a desired frequency range, within a desired power range and/or within a desired loudness range.

One should also note that a diagram similar to the one of FIG. 11 can be generated and drawn for the sound suppression (i.e. a diagram of the sound suppression over the ratio BAL between the actuator signal and the speaker signal and over the phase shift Δφ for a particular frequency f, for a particular total power of the electrodynamic actuator 9 and the speaker 10 and for a particular loudness) so as to find out a usable maximum MAX, MAX′. Again, a number of diagrams may be generated within a desired frequency range, within a desired power range and/or within a desired loudness range. Equally, diagrams similar to the one of FIG. 11 can be generated and drawn for the parameters K₁ . . . K₈ (i.e. diagrams of the parameters K₁ . . . K₈ over the ratio BAL between the actuator signal and the speaker signal and over the phase shift Δφ for a particular frequency f, for a particular total power of the electrodynamic actuator 9 and the speaker 10 and for a particular loudness) so as to find out a maximum MAX, MAX′. Again, a number of diagrams may be generated within a desired frequency range, within a desired power range and/or within a desired loudness range.

So, generally speaking, the sound suppression and the improvement of the signal to noise ratio ΔSNR are substantially influenced by the ratio and the phase shift Δφ between the actuator signal and the speaker signal, by the frequency f, by the total power of the electrodynamic actuator 9 and the speaker 10 and by the loudness. In particular, tuning of the acoustic system can be done at a (nominal) loudness of 75 dB and/or for a sinusoidal audio input signal AUD at a frequency of 3 kHz. Generally, the sound suppression and the improvement of the signal to noise ratio ΔSNR or one of the parameters K₁ . . . K₈ may act as or form “tuning parameters” in the aforementioned technical disclosure. In addition, the average of one or more of the tuning parameters within a given distance range, on the off-ear axis OEA or in the cone volume CV can be taken as a measure for tuning (see FIG. 1 in this context).

Advantageously, sound suppression can be limited to a particular frequency range. For example, sound S2 . . . S2′ transmitted over air including the sound S2″ transmitted over air originating from the electrodynamic actuator 9 can be less loud in a frequence range of 20 Hz to 20 kHz. In this way, the proposed measures for sound suppression can be limited to an audible frequency range so that the tuning of the acoustic system 1a . . . 1b′ may get easier. In particular, the frequency range can be limited to a range of 1 kHz to 10 kHz and hence to a frequency range, in which the electrodynamic actuator 9 is considered to operate efficiently and in which a substantial sound suppression can be achieved.

Beneficially of a ratio BAL and a phase shift Δφ between the actuator signal ACS and the speaker signal SPS at a given frequency f can vary over a total output power of the electrodynamic actuator 9 and the speaker 10. In this way, non-linearities of the electrodynamic actuator 9 and the speaker 10 leading to varying efficiency over frequency f can be taken into account.

Generally, one should also note that generation of the actuator signal ACS and the speaker signal SPS beneficially can be done without the use of a microphone and/or an acceleration sensor of the acoustic system 1a . . . 1b′. That means that no sensor measurement is required for the proposed sound suppression, but this is done only based on the audio input signal AUD. However, the use of microphone and/or an acceleration sensor in the acoustic system 1a . . . 1b′ is not excluded.

By the proposed measures, disturbance to people in the vicinity of the user 3 is avoided and privacy for the user 3 is ensured or at least improved.

Finally, one should note that the invention is not limited to the above-mentioned embodiments and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary and not limiting upon the scope of the present invention. The scope of the present invention is defined by the appended claims, including known equivalents and unforeseeable equivalents at the time of filing of this application. Although numerous embodiments of this invention have been described above with a certain degree of particularity, those skilled in the art could make numerous alterations to the disclosed embodiments without departing from the spirit or scope of this disclosure.

### LIST OF REFERENCES

1a . . . 1b′ acoustic system
2 acoustic device
3 user
4 ear
5 ear channel
6 bone tissue
7 soft tissue
8 housing
9 electrodynamic actuator
10 speaker
11 electronic sound signal circuit
12 battery
13 external sound source
14 external microphone
15 actuator center magnet
16 actuator top plate
17 actuator bottom plate
18 actuator ring
19, 19′ actuator coil
20 actuator magnet system
21 actuator coil arrangement
22 actuator motor
23 spring leg
24 moving mass
25 actuator housing/actuator frame
26 speaker center magnet
27 speaker top plate
28 speaker pot
29 speaker coil
30 speaker magnet system
31 speaker coil arrangement
32 speaker motor
33 membrane
34 speaker housing/speaker frame
35 actuator signal processing unit
36 speaker signal processing unit
37 actuator filter
38 delaying unit/phase shifting unit
39 actuator amplification stage
40 speaker filter
41 privacy enhancement filter
42 summing unit
43 speaker amplification stage
44 audio source
45 signal generation device
46 sound emitting device
47 sender
48 receiver
49 combined actuator speaker device
50 flexible membrane part
51 rigid membrane part
52 outer magnet system part
53 inner magnet system part
54 common magnet system
α cone opening angle
d distance ear/location offside of user
P1 offside location
ACA actuator axis
SPA speaker axis
OEA off-ear axis
C (virtual) cone
CV cone volume
SES sound emitting surface (speaker)
B, B′ magnetic field
F force
S1 sound (structure-borne sound originating from actuator)
S2, S2′ sound (airborne sound originating from speaker) S2″ sound (airborne sound originating from actuator) SI audio input
SO1 actuator sound output
SO2 speaker sound output
SP1 actuator signal path
SP2 speaker signal path
ΔT delay time
Δφ phase shift
AUD audio input signal
ACS actuator signal
SPS speaker signal
ACS′ filtered actuator signal
f frequency
f cutoff frequency
f1 first frequency
f2 second frequency
L signal level
ACF, ACF′ actuator filter curve
SPF, SPF′ speaker filter curve
PEF privacy enhancement filter curve
BAL ratio between speaker signal and actuator signal
ΔSNR improvement of signal to noise ratio
MAX, MAX′ maximum

What is claimed is:

1. An acoustic system (1a . . . 1b′) comprising:
a housing (8), of which at least a part is intended to be pressed against a head of a user (3) for acoustic bone conduction,
an electrodynamic actuator (9) with an actuator motor (22) and a moving mass (24) driven by the actuator motor (22) or formed by a part of the actuator motor (22), wherein the electrodynamic actuator (9) is acoustically coupled to the housing (8) and designed to emit sound (S1) to be transmitted primarily by bone conduction, and
a speaker (10) with a speaker motor (32) and a membrane (33) driven by the speaker motor (32), wherein the speaker (10) is designed to emit sound (S2, S2′) to be transmitted primarily by air conduction,
wherein
the acoustic system (1a . . . 1b′) additionally comprises an electronic sound signal circuit (11), which is designed to generate an actuator signal (ACS) for driving the actuator motor (22) and a speaker signal (SPS) for driving the speaker motor (32) based on an audio input signal (AUD) in a way that in an offside location (P1) offside of the user (3), offside sound (S2′, S2″) transmitted over air including sound (S2″) transmitted over air originating from the electrodynamic actuator (9) is less loud than in a state, in which the speaker (10) is turned off.

2. The acoustic system (1a . . . 1b′) as claimed in claim 1, wherein the offside location (P1) is arranged in a cone volume (CV) of a cone (C), which opens from a user's ear (4), at which the housing (8) contacts the user (3) for bone conduction, wherein the cone (C) opens at an angle (α) of 120° with respect to an off-ear axis (OEA), which is a horizontal axis perpendicular to a viewing direction of the user (3) starting at an ear canal (5) of the user (3).

3. The acoustic system (1a . . . 1b′) as claimed in claim 1, wherein at a loudness of 75 dB perceived by the user (3), in the offside location (P1) offside of the user (3),
$${K}_{1} = \frac{S S U P}{{P}_{ACS} + {P}_{S P S}} > 10 {W}^{- 1}$$
and/or
the parameter K₁ reaches a maximum in view of a change of a ratio (BAL) between the actuator signal (ACS) and the speaker signal (SPS) or in view of a change of a phase shift (Δφ) between the actuator signal (ACS) and the speaker signal (SPS),
wherein P_{ACS} is an electric power of the actuator signal (ACS), P_{SPS} is an electric power of the speaker signal (SPS) and SSUP is a sound suppression caused by the speaker (10) in the offside location (P1) in relation to the speaker (10) being turned off.

4. The acoustic system (1a . . . 1b′) as claimed in claim 1, wherein in the offside location (P1) offside of the user (3),
$${K}_{2} = \frac{{P}_{A C S}}{{P}_{A C S} + {P}_{S P S}} \cdot SSUP > 1.3$$
and/or
the parameter K₂ reaches a maximum in view of a change of a ratio (BAL) between the actuator signal (ACS) and the speaker signal (SPS) or in view of a change of a phase shift (Δφ) between the actuator signal (ACS) and the speaker signal (SPS),
wherein P_{ACS} is an electric power of the actuator signal (ACS), P_{SPS} is an electric power of the speaker signal (SPS) and SSUP is a sound suppression caused by the speaker (10) in the offside location (P1) in relation to the speaker (10) being turned off.

5. The acoustic system (1a . . . 1b′) as claimed in claim 1, wherein at a loudness of 75 dB perceived by the user (3), in the offside location (P1) offside of the user (3),
$${K}_{5} = \frac{S SUP \cdot Δ SNR}{{P}_{ACS} + {P}_{S P S}} > 20 {W}^{- 1}$$
and/or
the parameter K₅ reaches a maximum in view of a change of a ratio (BAL) between the actuator signal (ACS) and the speaker signal (SPS) or in view of a change of a phase shift (Δφ) between the actuator signal (ACS) and the speaker signal (SPS),
wherein P_{ACS} is an electric power of the actuator signal (ACS), P_{SPS} is an electric power of the speaker signal (SPS), SSUP is a sound suppression caused by the speaker (10) in the offside location (P1) in relation to the speaker (10) being turned off and ΔSNR is an improvement of a signal to noise ratio between a loudness of the sound (S1, S2) perceived by the user (3) or a user model and a sound pressure level of the offside sound (S2′, S2″) in said offside location (P1) caused in the on-state of the speaker (10) in relation to a state, in which the speaker (10) is turned off.

6. The acoustic system (1a . . . 1b′) as claimed in claim 1, wherein the electronic sound signal circuit (11) is designed to cause a sound suppression in the offside location (P1) in the on-state of the speaker (10) in relation to the off-state of the speaker (10) at a loudness of 75 dB perceived by the user (3) and/or for a sinusoidal audio input signal (AUD) at a frequency of 3 kHz.

7. The acoustic system (1a . . . 1b′) as claimed in claim 1, wherein of a ratio (BAL) and a phase shift (Δφ) between the actuator signal (ACS) and the speaker signal (SPS) at a given frequency (f) vary over a total output power of the electrodynamic actuator (9) and the speaker (10).

8. The acoustic system (1a . . . 1b′) as claimed in claim 1, wherein the electronic sound signal circuit (11) for a hearing perception of the user (3) is designed to mix both sound (S1) originating from the electrodynamic actuator (9), which primarily is transmitted by bone conduction, and sound (S2) originating from the speaker (10), which primarily is transmitted by air conduction, wherein a share of the hearing perception of the user (3) formed by sound (S1) originating from the electrodynamic actuator (9) and a remaining share of the hearing perception of the user (3) formed by sound (S2) originating from the speaker (10) vary over the frequency (f) of the sound (S1, S2).

9. The acoustic system (1a . . . 1b′) as claimed in claim 8, wherein the share formed by the sound (S1) originating from the electrodynamic actuator (9) is higher than the remaining share formed by the sound (S2) originating from the speaker (10)
above a cutoff frequency (f) or
above a first frequency (f1) and below a higher second frequency (f2).

10. The acoustic system (1a . . . 1b′) as claimed in claim 1, wherein the electronic sound signal circuit (11) is designed to generate a filtered actuator signal (ACS′) as part of the speaker signal (SPS).

11. The acoustic system (1a . . . 1b′) as claimed in claim 1, wherein the electronic sound signal circuit (11) is designed to provide a delay time (ΔT) or phase shift (Δφ) between sound (S2, S2″) transmitted over air, which originates from the electrodynamic actuator (9), and sound (S2, S2′) transmitted over air originating from the speaker (10).

12. The acoustic system (1a . . . 1b′) as claimed in claim 1, wherein the electronic sound signal circuit (11) comprises:
an audio input (SI) being designed to receive the audio input signal (AUD),
an actuator sound output (SO1), which is connected to the actuator motor (22), a speaker sound output (SO2), which is connected to the speaker motor (32), an actuator signal path (SP1) between the audio input (SI) and the actuator sound output (SO1) and a speaker signal path (SP2) between the audio input (AUD) and the speaker sound output (SO2), an actuator signal processing unit (35), which is arranged in the actuator signal path (SP1) and which is designed to generate the actuator signal (ACS) based on the audio input signal (AUD) and to feed the actuator signal (ACS) to the actuator sound output (SO1), and a speaker signal processing unit (36), which is arranged in the speaker signal path (SP2) and which is designed to generate the speaker signal (SPS) based on the audio input signal (AUD) and to feed the speaker signal (SPS) to speaker sound output (SO2).

13. The acoustic system (1a . . . 1b′) as claimed in claim 12, wherein
the actuator signal processing unit (35) comprises an actuator filter (37) and/or
the speaker signal processing unit (36) comprises a speaker filter (40).

14. The acoustic system (1a . . . 1b′) as claimed in claim 13, wherein the actuator filter (37) and the speaker filter (40) provide both
mixing sound (S1) originating from the electrodynamic actuator (9) and sound (S2, S2′) originating from the speaker (10) according to claim 18 or 19 and
generating a filtered actuator signal (ACS′) as part of the speaker signal (SPS) according to claim 20.

15. The acoustic system (1a . . . 1b′) as claimed in claim 1, wherein an actuator axis (ACA), along which the actuator motor (22) moves, and a speaker axis (SPA), along which the speaker motor (32) moves,
are parallel to each other,
are turned against each other by 90° or
coincide.

16. The acoustic system (1a . . . 1b′) as claimed in claim 1, wherein
a) the housing (8), the electrodynamic actuator (9), the speaker (10) and the electronic sound signal circuit (11) are part of a single acoustic device (2) or
b) the housing (8), the electrodynamic actuator (9) and the speaker (10) are part of a sound emitting device (46) and the electronic sound signal circuit (11) is part of a separate signal generation device (45),
wherein in case b) the signal generation device (45) is designed to generate the actuator signal (ACS) and the speaker signal (SPS) and to transmit the actuator signal (ACS) and the speaker signal (SPS) to the sound emitting device (46) and
wherein in case b) the sound emitting device (46) is designed to receive the actuator signal (ACS) and the speaker signal (SPS) from the signal generation device (45) and to emit the sound (S1, S2, S2′) based on the actuator signal (ACS) and the speaker signal (SPS).

17. The acoustic system (1a . . . 1b′) as claimed in claim 16, wherein
in case a) the acoustic output device (2) is embodied as a headphone, a headset, a hearing aid or a mobile phone, or
in case b) the sound emitting device (46) is embodied as a headphone, a headset or a hearing aid and the signal generation device (45) is embodied as a mobile phone, a tablet computer or a desktop computer.

18. A signal generation device (45) for generating an actuator signal (ACS) and a speaker signal (SPS) and for transmitting the actuator signal (ACS) and the speaker signal (SPS) to a sound emitting device (46), wherein the sound emitting device (45) comprises:
a housing (8), of which at least a part is intended to be pressed against a head of a user (3) for acoustic bone conduction,
an electrodynamic actuator (9) with an actuator motor (22) and a moving mass (24) driven by the actuator motor (22) or formed by a part of the actuator motor (22), wherein the electrodynamic actuator (9) is acoustically coupled to the housing (8) and designed to emit sound (S1) to be transmitted primarily by bone conduction, and
a speaker (10) with a speaker motor (32) and a membrane (31) driven by the speaker motor (32), wherein the speaker (10) is designed to emit sound (S2, S2′) to be transmitted primarily by air conduction, and
wherein the signal generation device (45) comprises an electronic sound signal circuit (11), which is designed to generate an actuator signal (ACS) for the actuator motor (22) a and a speaker signal (SPS) for driving the speaker motor (32) based on an audio input signal (AUD) in a way that in an offside location (P1) offside of the user (3), offside sound (S2′, S2″) transmitted over air including sound (S2″) transmitted over air originating from the electrodynamic actuator (9) is less loud than in a state, in which the speaker (10) is turned off.

19. A method of operating an acoustic system (1a . . . 1b′) as claimed in claim 1,
wherein the electronic sound signal circuit (11) generates an actuator signal (ACS) for driving the actuator motor (20) and a speaker signal (SPS) for driving the speaker motor (30) based on an audio input signal (AUD) in a way that in an offside location (P1) offside of the user (3), offside sound (S2′, S2″) transmitted over air including sound (S2″) transmitted over air originating from the electrodynamic actuator (9) is less loud than in a state, in which the speaker (10) is turned off.

20. A method of tuning an acoustic system (1a . . . 1b′) as claimed in claim 1, the method comprising the steps of
applying an audio input signal (AUD) to the acoustic system (1a . . . 1b′),
measuring offside sound (S2′, S2″) generated by the acoustic system (1a . . . 1b′) in an offside location (P1) offside of the user (3) or offside an equivalent arrangement of the acoustic system (1a . . . 1b′) on a user model,
setting a ratio (BAL) between the actuator signal (ACS) and the speaker signal (SPS) and a phase shift (Δφ) between the actuator signal (ACS) and the speaker signal (SPS) in a way that offside sound (S2′, S2″) transmitted over air in said offside location (P1) is less loud than in a state, in which the speaker (10) is turned off, and
setting the chosen ratio (BAL) and the chosen phase shift (Δφ) in the electronic sound signal circuit (11).
